(19) United States
(12) Patent Application Publication
(10) Pub. No.: US 2024/0430819 A1
(43) Pub. Date: Dec. 26, 2024

(54) SRS-BASED CHANNEL RECONSTRUCTION IN HYBRID SYSTEMS

(71) Applicant: Samsung Electronics Co., Ltd., Suwon-si (KR)

(72) Inventors: Ahmad AlAmmouri, Richardson, TX (US); Jianhua Mo, Allen, TX (US); Younghan Nam, Plano, TX (US)

(21) Appl. No.: 18/737,904

(22) Filed: Jun. 7, 2024

Related U.S. Application Data
(60) Provisional application No. 63/522,967, filed on Jun. 23, 2023.

(51) Int. Cl. H04W 52/34; H04L 5/00; H04W 72/044

(52) U.S. Cl. CPC H04W 52/34; H04L 5/005; H04W 72/046

(57) ABSTRACT

Techniques for implementations of hybrid wireless systems, methods, and apparatuses are introduced. In one aspect of the disclosure, a base station (BS) configures a group that specifies a plurality of sounding reference signal (SRS) resource sets. The BS also configures a power control rule that ensures all SRSs corresponding to the SRS resource sets in the group are transmitted with the same UE power. The BS receives from the UE the SRSs associated with the SRS resource sets in the group and identifies one or more beams for use in reconstructing the channel and optimizing subsequent data exchanges.

### CROSS-REFERENCE TO RELATED APPLICATIONS

This application claims the benefit of priority from U.S. Provisional Application No. 63/522,967 entitled “SRS-BASED CHANNEL RECONSTRUCTION IN HYBRID SYSTEMS,” filed Jun. 23, 2023, which is incorporated herein by reference in its entirety.

### TECHNICAL FIELD

This disclosure relates generally to a wireless communication system, and more particularly to, for example, but not limited to, sounding reference signals (“SRSs”) in wireless communication systems.

### BACKGROUND

Wireless communication devices, including but not limited to today's LTE and 5G NR systems and the 6G technologies under current commercial development, are increasingly required to reliably support both a growing number of users and the expanding emergence of delay-sensitive and real-time applications. These applications include robotics, artificial intelligence (AI), cloud computing, unmanned vehicles, control systems, and the internet of things (IoT), to name a few.

One such technology historically crucial to the fast acquisition of channel-state information to facilitate reliable data exchanges includes sounding reference signal (“SRS”) channel reconstruction. In modern beamforming, for example, SRS is particularly important to achieve reliable channel estimation and consequently, high transmit capacity and quality. As bandwidth requirements continue to escalate, SRS has met with shortcomings. Problems with SRS include unequal transmit powers and power wastage in the devices, both of which phenomena tend to result in performance losses adversely affecting users and corresponding processing resources.

The description set forth in the background section should not be assumed to be prior art merely because it is set forth in the background section. The background section may describe aspects or embodiments of the present disclosure.

### SUMMARY

An aspect of the present disclosure provides a base station. The base station includes a transceiver. The transceiver is configured to transmit, to a user equipment (UE), resource set group information. The resource set group information includes identifiers (IDs) of a plurality of sounding reference signal (SRS) resource sets. Each of the plurality of SRS resource sets corresponds to a different receive beam. The transceiver is further configured to transmit a power control rule to ensure a constant transmit power across the plurality of SRS resource sets. The transceiver is configured to receive SRSs on at least one SRS resource set of the plurality of SRS resource sets. The BS further includes a processor operably coupled to the transceiver. The processor is configured to, based on the received SRSs, identify a beam.

In some embodiments, the beam is identified based on reconstructed channel information.

In some embodiments, the processor is further configured to measure a metric for each of the received SRSs, and the beam corresponds to a beam with a highest metric.

In some embodiments, the metric is one of signal-to-noise ratio (SNR), signal-to-interference-plus-noise ratio (SINR), or reference signal received power (RSRP).

In some embodiments, the power control rule is configured to ensure precedence over other transmit power rules in the plurality of SRS resource sets.

In some embodiments, the power control rule relates to use of a maximum power, a minimum power, a mean power, a median power, or a weighted sum of a plurality of transmit powers, as a transmit power for the SRSs, and the plurality of transmit powers correspond to the plurality of SRS resource sets.

In some embodiments, the resource set group information includes a parameter to allow selective transmission of SRSs on at least one active SRS resource set.

An aspect of the present disclosure provides a user equipment (UE). The UE includes a transceiver. The transceiver is configured to receive, from a base station (BS), resource set group information including identifiers (IDs) of a plurality of sounding reference signal (SRS) resource sets. Each of the plurality of SRS resource sets corresponds to a different receive beam. The transceiver is further configured to receive a power control rule to ensure a constant transmit power across the plurality of SRS resource sets. The UE includes a processor operably coupled to the transceiver. The processor is configured to identify at least one active SRS resource set of the plurality of SRS resource sets. The processor is also configured to determine the constant transmit power for the at least one active SRS resource set using the power control rule. The transceiver is further configured to transmit SRSs on the at least one active SRS resource set.

In some embodiments, the transceiver is further configured to receive, from the BS after transmitting the SRSs on the at least one active SRS resource set of the plurality of SRS resource sets, an identity of a beam.

In some embodiments, the resource set group information includes a parameter to instruct the UE to selectively transmit the SRSs on the at least one active SRS resource set of the plurality of SRS resource sets.

In some embodiments, the parameter includes a power threshold or a power headroom threshold for enabling the processor to identify the at least one active SRS resource set of the plurality of SRS resource sets.

In some embodiments, the transceiver is further configured to receive, from the BS, medium access control (MAC) control elements (CEs) for the UE to determine at least one active SRS resource set used for the UE to transmit SRSs. Each of the MAC CEs includes an identifier of an SRS resource set and a field indicating whether the identified SRS resource set is activated or deactivated.

In some embodiments, the power control rule relates to use of a maximum power, a minimum power, a mean power, a median power, or a weighted sum of a plurality of transmit powers, as a transmit power for the SRSs. The plurality of transmit powers correspond to the plurality of SRS resource sets.

In some embodiments, the power control rule is configured to ensure precedence over other transmit power rules in the plurality of SRS resource sets.

An aspect of the present disclosure provides a method performed by a base station (BS). The method includes transmitting, to a user equipment (UE), resource set group information including identifiers (IDs) of a plurality of sounding reference signal (SRS) resource sets. Each of the plurality of SRS resource sets corresponds to a different receive beam. The method further includes transmitting to the UE a power control rule to ensure a constant transmit power across the plurality of SRS resource sets. The method includes receiving SRSs on at least one SRS resource set of the plurality of SRS resource sets. The method also includes identifying, based on the received SRSs, a beam.

In some embodiments, the beam is identified based on reconstructed channel information.

In some embodiments, the method further includes measuring a metric for each of the received SRSs. The beam corresponds to a beam with a highest metric.

In some embodiments, the metric is one of signal-to-noise ratio (SNR), signal-to-interference-plus-noise ratio (SINR), or reference signal received power (RSRP).

In some embodiments, the power control rule is configured to ensure precedence over other transmit power rules in the plurality of SRS resource sets.

In some embodiments, the power control rule relates to use of a maximum power, a minimum power, a mean power, a median power, or a weighted sum of a plurality of transmit powers, as a transmit power for the SRSs. The plurality of transmit powers correspond to the plurality of SRS resource sets.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example of a beamforming architecture in accordance with an embodiment.

FIG. 5 shows an example of an antenna panel partitioned into subarrays in accordance with an embodiment.

FIG. 6 shows an example of an RF frontend and baseband implementation for a BS equipped with the antenna panels in FIG. 5, in accordance with an embodiment.

FIG. 7 shows an example of a sounding reference signal (SRS) reception and processing architecture in accordance with an embodiment.

FIG. 8 shows an example of an SRS activation/deactivation signaling field for medium access control (“MAC”) control elements (“MAC CE”) in accordance with an embodiment.

FIG. 9 shows an example conceptual diagram explaining the effect of unequal UE transmit (“TX”) power in accordance with an embodiment.

FIG. 10A shows an example signaling field for grouping SRS resource sets used for channel reconstruction in accordance with an embodiment.

FIG. 10B shows an example signaling field for enabling a BS to add resource set groups in accordance with an embodiment.

FIG. 11 shows an example signaling diagram between a UE and BS for transmitting data to the UE based on a common TX power for all SRSs on active SRS resource sets according to an embodiment.

FIG. 12 shows an example flow diagram of a UE determining a common UE TX power using automatic on/off in accordance with an embodiment.

FIG. 13A shows an example signaling field showing a MAC CE for activation or deactivation of individual SRS resources in accordance with an embodiment.

FIG. 13B shows an example signaling field showing a flag to indicate to the UE to transmit SRSs on active SRS resources in accordance with an embodiment.

FIG. 14 shows an example flow diagram illustrating a UE storing and processing data in preparing for SRS transmissions in accordance with an embodiment.

FIG. 15 shows another example flow diagram illustrating a UE storing and processing data in accordance with an embodiment.

FIG. 16 shows another example flow diagram for a UE transmitting SRSs with automatic on/off activation capabilities in accordance with an embodiment.

FIG. 17 shows another example flow diagram for a base station performing an SRS-based channel reconstruction in accordance with an embodiment.

FIG. 18 is an example signaling diagram for SRS channel reconstruction in accordance with an embodiment.

FIG. 19 is another example signaling diagram for deactivating beams in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR (New Radio) systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. The key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHZ, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

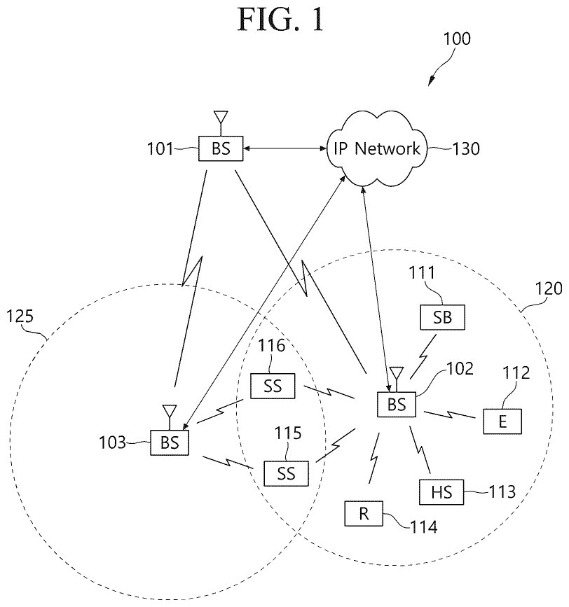

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

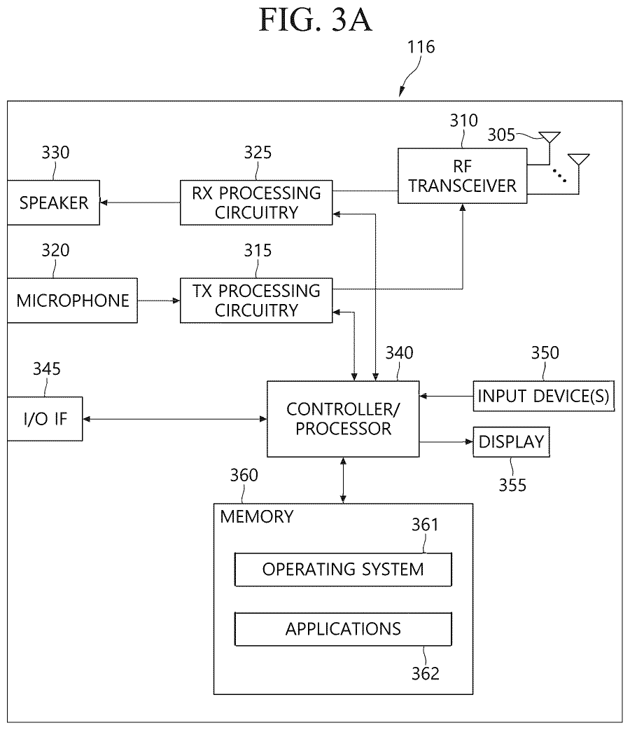

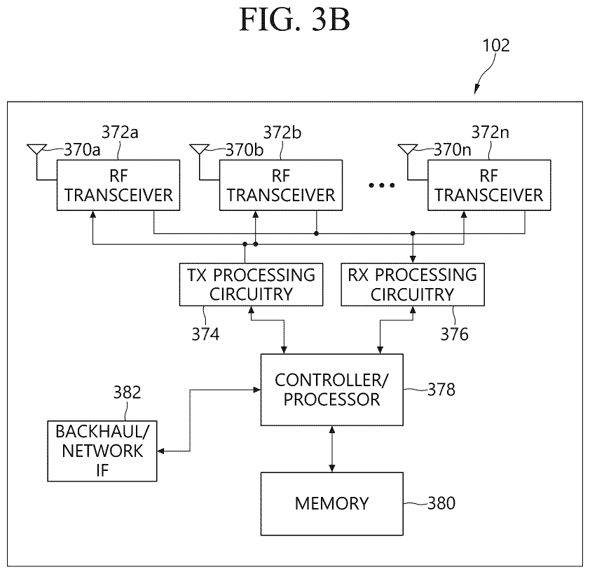

As shown with reference to FIG. 3B, below, the TX processing circuitry 374 of the BS receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor can include one or more processors or other processing devices that control the overall operation of the BS 101. For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor could support beamforming or directional routing operations in which outgoing signals from multiple antennas are weighted differently to effectively steer the outgoing signals in a desired direction. The controller/processor could also support OFDMA operations in which outgoing signals may be assigned to different subsets of subcarriers for different recipients (e.g., different UEs 111-114). Any of a wide variety of other functions could be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other devices or systems over a backhaul connection or over a network. The interface could support communications over any suitable wired or wireless connection(s). For example, the interface could allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory could include a RAM, and another part of the memory could include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

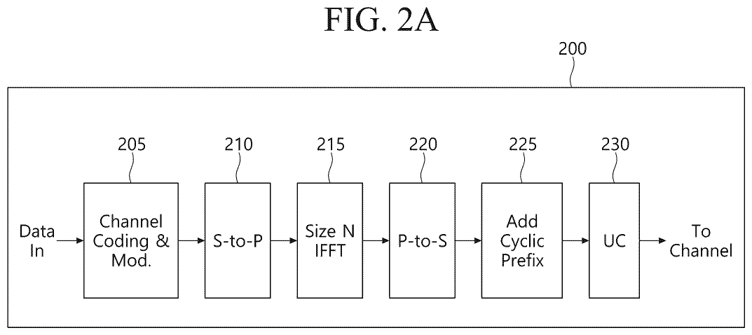

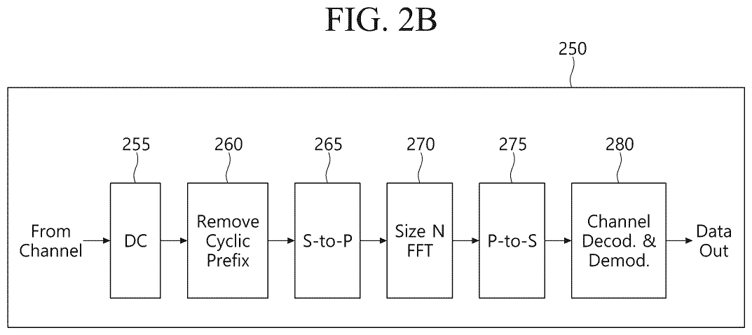

FIG. 2A shows an example of a wireless transmit path 200 in accordance with an embodiment. FIG. 2B shows an example of a wireless receive path 250 in accordance with an embodiment. In the following description, a transmit path 200 may be implemented in a gNB/BS (such as BS 102), while a receive path 250 may be implemented in a UE (such as UE 116). However, it will be understood that the receive path 250 can be implemented in a BS and that the transmit path 200 can be implemented in a UE. In some embodiments, the receive path 250 is configured to support the codebook design and structure for systems having 2D antenna arrays as described in embodiments of the present disclosure. That is to say, each of the BS and the UE each include transmit and receive paths such that duplex communication (such as a voice conversation) is made possible.

The transmit path 200 includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before it is transmitted, a parallel-to-serial (P-to-S) block 220 for serializing the block into a single datastream (noting that BSs/UEs with multiple transmit paths may each transmit a separate datastream), an add cyclic prefix block 225 for appending a guard interval that is a replica of the end part of the orthogonal frequency domain modulation (OFDM) symbol (or whatever modulation scheme is used) and is generally at least as long as the delay spread to mitigate effects of multipath propagation, and an up-converter (UC) 230 for modulating the baseband (or in some cases, intermediate frequency (IF)) signal onto the carrier signal to be used for transmission across an antenna. The receive path 250 essentially includes the opposite circuitry and includes a down-converter (DC) 255 for removing the datastream from the carrier signal, a remove cyclic prefix block 260 for removing the guard interval (or removing the interval of a different length), a serial-to-parallel (S-to-P) block 265 for taking the datastream and parallelizing it for faster operations, a size N Fast Fourier Transform (FFT) block 270 for converting the N time-domain signals to symbols in the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in the transmit path 200.

As a further example, in the transmit path 200, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), etc.) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memories. Each of the BSs 101-103 may implement a transmit path 200 that is analogous to transmitting in the downlink to UEs 111-116, Likewise, each of the BSs 101-103 may implement a receive path 250 that is analogous to receiving in the uplink from UEs 111-116. Similarly, to realize bidirectional signal execution, each of UEs 111-116 may implement a transmit path 200 for transmitting in the uplink to BSs 101-103 and each of UEs 111-116 may implement a receive path 250 for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

FIG. 3A shows an example of a user equipment (“UE”) 116 in accordance with an embodiment. It should be underscored that the embodiment of the UE 116 illustrated in FIG. 3A is for illustrative purposes only, and the UEs 111-115 of FIG. 1 can have the same or similar configuration. However, UEs come in a wide variety of configurations, and the UE 116 of FIG. 3A does not limit the scope of this disclosure to any particular implementation of a UE. Referring now to the components of FIG. 3A, the UE 116 includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 116 also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display may also constitute an input touchpad and in that case, it may be bidirectionally coupled with the processor 340.

The RF transceiver may include multiple physical components, depending on the sophistication and configuration of the UE. The RF transceiver 310 receives from antenna 305, an incoming RF signal transmitted by a BS of the network 100. The RF transceiver 310 thereupon down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The main processor 340 is also capable of executing other processes and programs resident in the memory 360, such as operations for supporting SRS-based channel reconstruction as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 116 with the ability to connect to other devices such as laptop computers and handheld computers. The I/O interface 345 is the communication path between these accessories and the main controller 340. The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 116 of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 116 may include separate processors, or they may be controlled in part or in full by firmware or middleware. For example, any one or more of the components of UE 116 may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 116 may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 116, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 102 in accordance with an embodiment. As noted, the terminology BS and gNB may be used interchangeably for purposes of this disclosure. The embodiment of the BS 102 shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. It is noted that BS 101 and BS 103 can include the same or similar structure as BS 102, or they may have different structures. As shown in FIG. 3B, the BS 102 includes multiple antennas 370a-370n, multiple corresponding RF transceivers 372a-372n, transmit (TX) processing circuitry 374, and receive (RX) processing circuitry 376. In certain embodiments, one or more of the multiple antennas 370a-370n include 2D antenna arrays. The BS 102 also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 102. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 102 by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of executing programs and other processes resident in the memory 380, such as processes for SRS-based channel reconstruction as described in embodiments of the present disclosure. The processor 378 can move data into or out of the memory 380 as required by an executing process. A backhaul or network interface 382 allows the BS 102 to communicate with other devices or systems over a backhaul connection or over a network. The interface 382 can support communications over any suitable wired or wireless connection(s). For example, when the BS 102 is implemented as part of a cellular communication system (such as one supporting 5G, 5G-A, LTE, or LTE-A, etc.), the interface 382 can allow the BS 102 to communicate with other BSs over a wired or wireless backhaul connection. When the BS 102 is implemented as an access point, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of an BS 102, various changes may be made to FIG. 3B. For example, the BS 102 can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 102 can include multiple instances of each (such as one transmission or receive per RF transceiver).

As an example, Rel. 13 LTE (cited below) supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 102 of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 102 may include separate processors, or they may be controlled in part or in full by firmware or middleware. For example, any one or more of the components of BS 102 may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 102 may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 102 was that of a structure on a tower, this depiction is exemplary only, and the BS may be present in other forms in accordance with well-known principles.

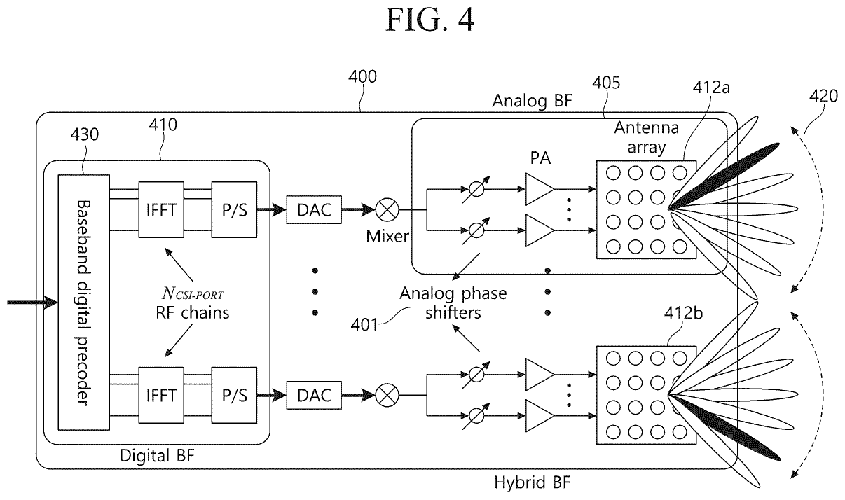

FIG. 4 shows an example of a hybrid beamforming architecture 400 in accordance with an embodiment. In some implementations, the beamforming architecture 400 may be implemented in a BS. In this example, the beamforming architecture 400 includes a baseband digital precoder 430. Precoder 430 may include a module that includes signal processing for providing individual control of the signals sent from the various transmit antennas 412a and 412b. Digital precoding may, for example, be used to enhance the performance of MIMO channels (i.e., where multiple antennas are used at both the transmitter and receiver to improve signal exchanges). Baseband digital precoding is configured to optimize a transmitted signal by adjusting the weights of the baseband digital data streams prior to their transmission. The BS can determine the spatial matrices for both the digital precoder and the analog beamformer to enable it to direct energy to specific spatial channels of one or more UEs simultaneously. Beamforming can dramatically increase the throughput capacity and is also useful at mm Wave frequencies.

Precoder 430 is included in digital beamforming unit 410. The digital beamforming unit 410 performs a linear combination across a number (N_{CSI-PORT}) of analog beams to further increase precoding gain. While analog beams are wideband (and thus not frequency-selective), digital precoding can be varied across frequency sub-bands or resource blocks. The number of sub-arrays (equal to the number of RF chains) is the same as the number of CSI-RS ports N_{CSI-PORT}. In digital beamforming module 410, each RF chain may include an IFFT module and a parallel to serial converter (e.g., multiplexer). Each RF chain from digital beamforming module 410 may be output to a respective digital-to-analog converter (DAC), and thereafter to a respective mixer for upconverting the respective signals to an RF frequency. The signals in the RF chains are then each provided to the analog phase shifters for shifting the phases of the signals. Each of the signals may then be boosted by a pre-amplifier (PA) before being provided to an antenna array, such as in the two exemplary antenna arrays shown, and transmitted as a narrow analog beam within an angle 420 from each array.

In this exemplary embodiment, one CSI-RS port is mapped onto a large number of antenna elements (e.g., antenna array 412a) which can be controlled by a bank of analog phase shifters 401. Each CSI-RS port can then correspond to one sub-array which produces a narrow analog beam through analog beamforming module 405. This analog beam can be configured to sweep across a wider range of angles 420 by varying the phase shifter bank 401 across symbols or subframes or slots (wherein a subframe or a slot comprises a collection of symbols and/or can comprise a transmission time interval (TTI)).

For mm Wave bands, although the number of antenna elements can be larger for a given form factor of the BS, the number of CSI-RS ports-which can correspond to the number of digitally precoded ports—tends to be limited due to hardware constraints (such as the feasibility to install a large number of analog-to-digital converters/digital-to-analog converters (ADCs/DACs) at mm Wave frequencies) as illustrated by beamforming architecture 400 in FIG. 4.

The anticipated adoption of hybrid beamforming is garnering increased momentum corresponding with recent interest in using upper-mid band carriers (such as 7 to 24 GHz carriers), which in turn allows for an extremely large number of antennas, e.g., 2048. However, having a large number of antennas renders a fully digital architecture impractical, due to the high-power consumption, costs, and other factors. These limitations likely make a hybrid architecture inevitable. In the hybrid scheme, a fewer number of digital chains, e.g., 256, drives the entire set of antenna arrays using subarrays structures.

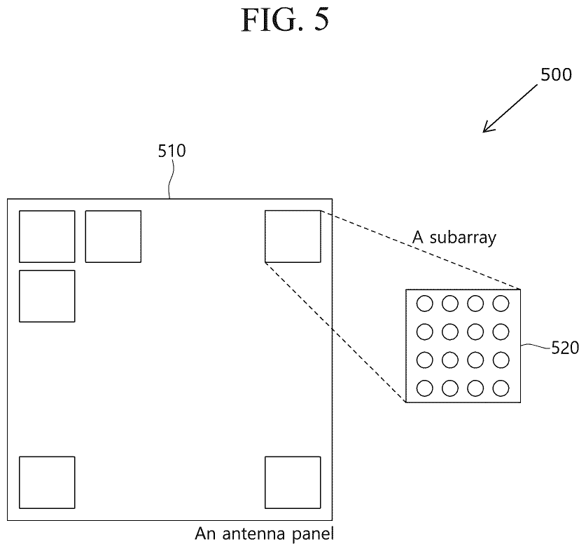

FIG. 5 shows an example diagram 500 of an antenna panel 510 partitioned into a plurality of subarrays 520 in accordance with an embodiment. Here, each digital chain may be connected to a single subarray 520, each subarray having a number (16 in this example) of antenna elements. Using a plurality of these antenna panels 510, a smaller number of digital chains can drive the antenna elements in a hybrid scheme. More generally, antenna panel 510 may include N_{T} elements, which are partitioned into subarrays of an equal number of elements denoted N_{A}. Using this nomenclature, the total number of subarrays may be denoted as N_{D} where N_{D}=N_{T}/N_{A}.

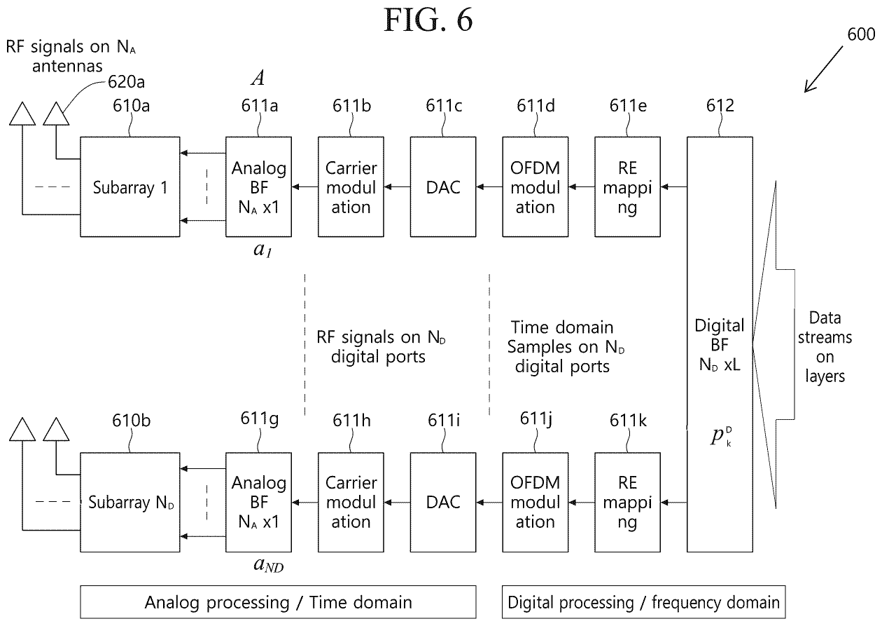

FIG. 6 shows an example of an RF frontend and baseband implementation 600 for a BS equipped with the antenna panels in FIG. 5, in accordance with an embodiment. Hybrid precoding generally involves a relatively low-dimension digital precoder while preserving the high dimension analog array of antenna elements. The organization of components in FIG. 6 enables the implementation of the hybrid beamforming scheme referenced above. With initial reference to the right of the illustration, L datastreams (e.g., L sequences of modulation symbols) may be provided to digital beamformer (BF) 612. The conversion of the number of datastreams involves BF 612 multiplying a digital precoder tensor pₖ^{D}, where pₖ^{D} is characterized by dimensions of N_{D}×L, by the resource elements comprising precoder bundle (PRB) k, wherein k=1, . . . , N_{PRB-bundles}. Thus, N_{PRB-bundles} is the total number of PRB bundles to which the data stream is mapped.

BF 612 may thereupon convert the L datastreams to N_{D} datastreams, with N_{D} being the total number of subarrays 610a-610b, each subarray having N_{A} antenna elements 620a. It should be noted that in this embodiment, the full channel is needed to compute the precoders.

While two are shown in FIG. 6 for simplicity, the BF 612 is coupled to a total of N_{D} digital ports. The modulation symbols on each of the N_{D} datastreams are then mapped to resource elements by the respective N_{D} components 611e-611k. The corresponding signals are then OFDM modulated by N_{D} components 611d-611j and are accordingly converted to time domain samples as indicated by the rightmost vertical dashed line in FIG. 6. These time domain samples are converted to the analog domain by the N_{D} DACs 611c-611i. The respective analog signals are RF modulated onto carrier frequencies using components 611b-611h prior to entering the N_{D} analog beamformers 611a-611g.

As the analog signal goes through the N_{D} analog BFs 611a-611g, an analog precoder tensor p^{A} of size N_{A}×1 is applied for path d, where d=1, . . . , N_{D}. Applying the analog BFs for the signals on all the N_{D} paths, the RF signals on N_{T}=N_{A}×N_{D} antenna elements are constructed.

As noted, to efficiently design the analog precoders, the BS needs to know the full-element (per antenna) channel per each user equipment (UE), which refers to the channel per analog port. To this end, sounding reference signals (SRSs) can be used to obtain the full-element channel as in the following description. The full-element channel state information (CSI) is first obtained and represented for example purposes as the vector labeled H, as characterized by:

$$H = [ \begin{matrix}{h}_{1} \\ ⋮ \\ {h}_{{N}_{D}}\end{matrix} ] ∈ {ℂ}^{{N}_{A} {N}_{D} \times L} , {N}_{T} = {N}_{A} {N}_{D} \qquad ( 0.1 )$$

Having obtained the full-element CSI, the parameters for each of the N_{D} analog BFs are now obtained. These include the eigenvector an and the matrix A as governed by the following:

$${a}_{n} = max\_eig ( E ( {h}_{n} {h}_{n}^{H} ) ) \qquad ( 0.2 )$$

$$A = [ \begin{matrix}{a}_{1} & 0 & … & 0 \\ 0 & {a}_{2} & … & 0 \\ ⋮ & ⋮ & ⋱ & ⋮ \\ 0 & 0 & … & {a}_{{N}_{D}}\end{matrix} ] ∈ {ℂ}^{{N}_{T} \times {N}_{D}}$$

A third step is to obtain the digital precoding matrix P by applying zero-forcing (ZF) precoding on a matrix G using the following equations:

$$G = {A}^{t} H ∈ {ℂ}^{{N}_{D} \times L} P = {( {GG}^{H} )}^{- 1} G ∈ {ℂ}^{{N}_{D} \times L} \qquad ( 0.3 )$$

In another embodiment, SRS-based channel reconstruction may be used. The UE transmits SRSs according to SRS-resource set configurations identified to the UE by the base station. For the specific case of channel-reconstruction, the process is relatively simple for the fully digital system, but more involved for hybrid systems. To illustrate the operation in a hybrid system, the following example is provided. A BS may be assumed to have N_{T} antennas, and N_{D} digital ports. Hence, every digital port is driving a subarray with

$${N}_{A} := \frac{{N}_{T}}{{N}_{D}}$$

elements, where each element is controlled through a phase shifter. In total, each subarray can have N_{A} orthogonal beams, denoted by pᵢ^{A}∈ [symbol] ^{N}^{_{A}}^{×1}, i∈[1, N_{A}]. Assuming single-antenna UE for simplicity, the received digital signal over the k^{th} subcarrier is:

$${y}_{k , i} = {{P}_{T}^{i} ( I ⊗ {p}_{i}^{A} )}^{H} {h}_{k} + {n}_{k} , \qquad ( 1 )$$

where y_{k,n}∈ [symbol] ^{N}^{_{D}}^{×1} is the received digital signals, P_{T}ⁱ is the UE TX power over the i^{th} RX beam, pᵢ^{A}∈ [symbol] ^{N}^{_{A}}^{×1} is the analog beam per subarray, i is the analog beam index, ⊗ is the Kronecker product, I∈ [symbol] ^{N}^{_{D}}^{×N}^{_{D}} is an identity matrix, hₖ∈ [symbol] ^{N}^{_{T}}^{×1} is the channel between a UE and the BS over the k^{th} subcarrier, nₖ is the thermal noise over the k^{th} subcarrier. In this case, (I⊗pᵢ^{A})∈ [symbol] ^{N}^{_{T}}^{×N}^{_{D}} is a projection matrix. The full channel estimate is obtained through the different analog beams as shown:

$${\tilde{h}}_{k} = {\sum }_{i ∈ [ 1 , {N}_{A} ]} ( I ⊗ {p}_{i}^{A} ) {y}_{k , i} . \qquad ( 2 )$$

In the noiseless configuration with equal UE Tx power across analog beams, if the measurements are combined from N_{A} orthogonal beams, then the full-element channel, i.e., hₖ=\tilde{h}ₖ can be perfectly recovered.

In another embodiment, channel reconstruction using SRS in hybrid systems can be implemented in a BS using the following set of procedures. The objective is to estimate the full-element channel and to use the estimated information to optimize both digital and analog beamforming using SRSs. It is initially assumed that the BS has N analog ports per each digital port. In this instance, the BS has N possible orthogonal analog beams. It is also assumed that vi is the combining matrix for i^{th} analog beam, and that Pₜ⁽ⁱ⁾ is the TX power used by UE for the RX beam i. Further, it is assumed that the UE at issue adapts its TX power based on the receiving beam from the BS, and that Pₜ⁽ⁱ⁾ is the TX power used by UE for the i^{th} RX beam. With these assumptions, Hⱼ is defined to be the channel between the UE and the BS over the j^{th} subcarrier (SC). Then the received signal before combining is:

$${y}_{i , j} = \sqrt{{P}_{t}^{( i )}} {H}_{j} + {n}_{i , j}$$

Following normalization of the signal to account for the increased power, the received signal after combining is:

$${\tilde{y}}_{i , j} = {v}_{i} {H}_{j} + \frac{{v}_{i} {n}_{i , j}}{\sqrt{{P}_{t}^{( i )}}}$$

Next it is assumed that the UE only transmits its SRS signal on a set of receive (RX) beams C. For example, within the set C there may be M strongest beams. With these assumptions and following spatial combining, the full-element CSI is:

$${\tilde{H}}_{j} = {\sum }_{i ∈ C} {v}_{i}^{H} {\tilde{y}}_{i , j}$$

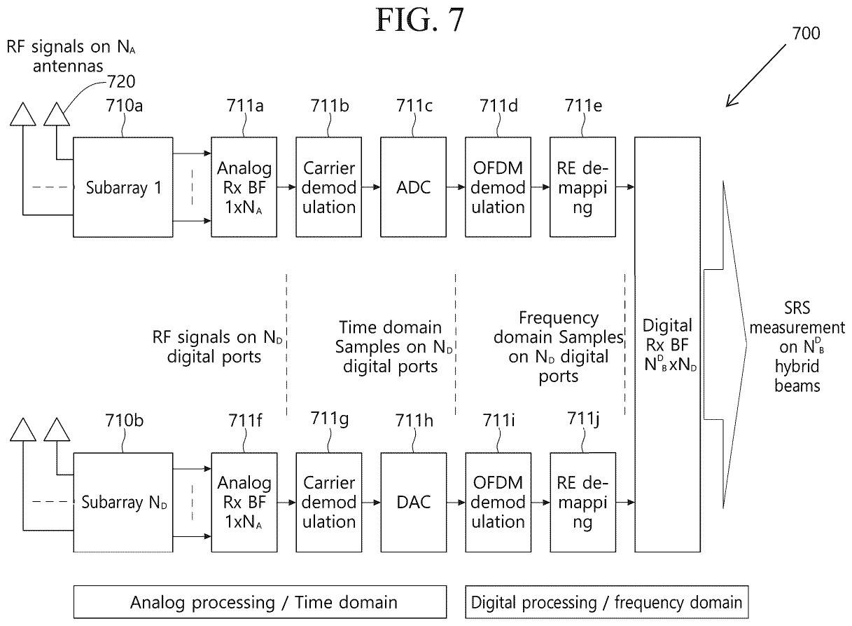

FIG. 7 shows an example of a sounding reference signal (SRS) reception and processing architecture 700 in accordance with an embodiment. The components are either identical or complementary to those of FIG. 6. In this case, SRS signals may be received at each of the N_{A} antennas 720 on subarrays 1 through N_{D} 710a-710b. As before, a total of N_{D} ports exists. Each of the N_{D} analog RX BFs 711a-711f receives from its corresponding subarray N_{A} data streams, as indicated by the two arrows and the vertical dashed line between each of the two example subarrays 710a-710b and the two example analog RX BFs 711a-711f. Each analog RX BF converts the N_{A} datastreams to a single datastream, leaving a total of N_{D} datastreams (one per digital port). The corresponding N_{D} datastreams are next demodulated from their RF carrier signal using the corresponding N_{D} demodulator components 711b-711g. Each demodulated datastream is then converted to digital form by one of the N_{D} ADC components 711c-711h. The digital symbols are then demodulated (e.g., using OFDM or OFDMA) into digital bitstreams using each of the N_{D} OFDM demodulators. It should be emphasized that other demodulation techniques (e.g., FSK, QAM, etc.) may be used here depending on the implementation. The N_{D} digital bitstreams are then de-mapped from their resource elements using components 711e-711j. The resulting bitstreams are provided to the digital RX BFs where the digital beamforming precoding information is extracted using the product N^{D}_{B}×N_{D}. The results are the SRS measurements on the N^{D}_{B} hybrid beams.

Another implementation may be based on the use of information elements (IEs). With signaling, the IEs SRS-Config, SRS-ResourceSet, and SRS-Resource are provided. The power control parameters are defined per SRS-ResourceSet. More specifically, all SRSs within the same SRS resource set have the same TX power. These parameters include alpha, p0, and pathlossReferenceRS. Example implementations may be used to reconstruct the full-element channel at the BS in the case of a hybrid beamformer are described below.

With this backdrop, at least the following two approaches may be used for configuring SRSs in the hybrid system case to reconstruct the full-element channel at the BS. In a first such approach, the BS may use a single SRS resource set (SRS-ResourceSet) with N_{A} resources based on data obtained from the radio resource control (RRC) layer as described in 3GPP TS 38.331 Release 17 (identified with specificity below as [4]). The different SRS resources may be configured to occur in different OFDM symbols. The UE repeats the SRS transmissions N_{A} times across the different resources while the BS sweeps through its N_{A} analog beams. The resource set may be configured as periodic, semi-periodic, or aperiodic. The usage field in this case can be set to beamManagement. Because the SRS signal may occupy a maximum of six (6) OFDM symbols, this approach is feasible in cases where N_{A}≤6. A further issue involving this approach is that individual resources cannot be activated or deactivated.

The second approach involves the use of multiple SRS resource sets. The BS may configure N_{A} SRS resource sets (SRS-ResourceSet) obtained through the RRC layer, as in the reference [4] below. Each resource set is associated with one BS RX beam through the CSI-RS Identifier (ID) by setting the parameter pathlossReferenceRS. These resource sets can, like the first approach, be configured as periodic, semi-periodic, or aperiodic. The usage field should be set to beamManagement. A drawback with this second approach is the requirement that a constant UE TX power needs to be maintained for any or all SRS transmissions across different SRS resource sets.

Summarizing the two approaches above, the first approach involves a single SRS Resource Set. The BS may use a single SRS resource set with N_{A} resources. The different resources may be configured to occur in different OFDM symbols. The UE repeats the SRS transmissions N_{A} times across the different resources while the BS sweeps through its N_{A} analog beams. The resource set could be configured as periodic, semi-periodic, or aperiodic. The usage field in this case can be set to beamManagement. Individual resources cannot be activated/deactivated.

The second approach, in summary, involves the use of multiple SRS resource sets. In the example above, the BS can configure N_{A} SRS-ResourceSets. Each resource set may be associated with a BS RX beam through the CSI-RS ID by setting the parameter pathlossReferenceRS. These resource sets may be configured as periodic, semi-periodic, or aperiodic. In addition, the usage field should also be set to beamManagement. As noted, across different SRS-Resource sets, a constant UE TX power needs to be obtained. The following aspects and embodiments are configured to address these issues.

The various fields (IEs) relevant to these approaches are set forth in the tables below. The RRC parameters for SRS-Config field are identified in Table 1 as set forth below. The RRC parameters for SRS-ResourceSet are set forth in Table 2.

TABLE 1

| | | |
|---|---|---|
| SRS-Config ::= | SEQUENCE { | |
| srs-ResourceSetToReleaseList | SEQUENCE (SIZE(1..maxNrofSRS- | OPTIONAL, -- Need |
| | ResourceSets)) OF SRS-ResourceSetId | N |
| srs-ResourceSetToAddModList | SEQUENCE (SIZE(1..maxNrofSRS- | OPTIONAL, -- Need |
| | ResourceSets)) OF SRS-ResourceSet | N |
| srs-ResourceToReleaseList | SEQUENCE (SIZE(1..maxNrofSRS- | OPTIONAL, -- Need |
| | Resources)) OF SRS-ResourceId | N |
| srs-ResourceToAddModList | SEQUENCE (SIZE(1..maxNrofSRS- | OPTIONAL, -- Need |
| | Resources)) OF SRS-Resource | N |
| tpc-Accumulation | ENUMERATED {disabled} | OPTIONAL, -- Need |
| | | S |
| ..., | | |
| } | | |

TABLE 2

| | | |
|---|---|---|
| SRS-ResourceSet ::= | SEQUENCE { | |
| srs-ResourceSetId | SRS-ResourceSetId, | |
| srs-ResourceIdList | SEQUENCE | OPTIONAL, -- |
| | (SIZE(1..maxNrofSRS- | Cond Setup |
| | ResourcesPerSet)) OF SRS- | |
| | ResourceId | |
| resourceType | CHOICE { | |
| aperiodic | SEQUENCE { | |
| ... | | |
| }, | | |
| semi-persistent | SEQUENCE { | |
| ... | | |
| }, | | |
| periodic | SEQUENCE { | |
| ... | | |
| }, | | |
| }, | | |
| usage | ENUMERATED | |
| | {beamManagement, codebook, | |
| | nonCodebook, antennaSwitching}, | |
| alpha | Alpha | OPTIONAL, -- |
| | | Need S |
| p0 | INTEGER (−202..24) | OPTIONAL, -- |
| | | Cond Setup |
| pathlossReferenceRS | PathlossReferenceRS-Config | OPTIONAL, -- |
| | | Need M |
| ... | | |
| } | | |

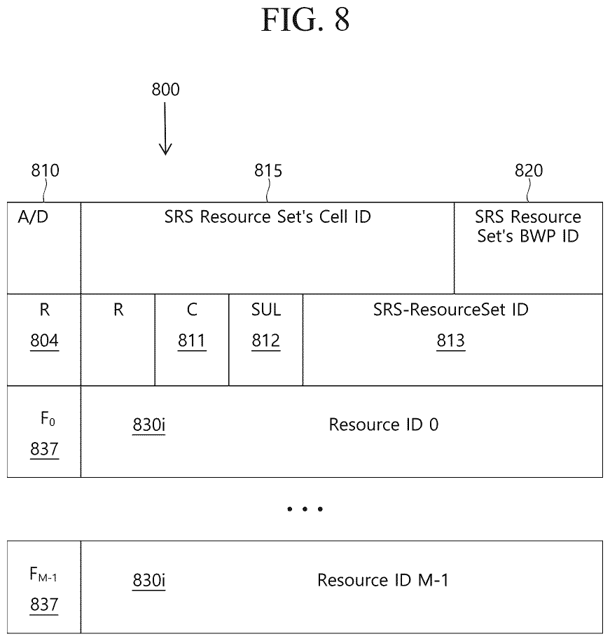

FIG. 8 shows an example of an SRS activation/deactivation signaling field 800 for medium access control (MAC) control elements (MAC CE) 800 in accordance with an embodiment. The parameters include Activate/Deactivate (A/D) 810, SRS Resource Set's Cell Identifier (ID) 815, and SRS Resource Set's Bandwidth Part identifier (BWP ID) 820. As shown in FIG. 8, the BS may activate an SRS-ResourceSet provided the BS was configured as semi-persistent using MAC-CE. The A/D field 810 indicates whether to activate or deactivate the indicated SRS resource set. The field is set to 1 to indicate activation; otherwise, it indicates deactivation. The SRS Resource Set's Cell ID field 815 is a five-bit field that indicates the identity of the Serving Cell, which includes activated/deactivated SP SRS Resource Set. If the C field 811 (discussed below) is set to 0, this field 815 also indicates the identity of the serving cell that includes all resources indicated by the Resource ID 0 through Resource ID M−1 (830i). The SRS Resource Set's BWP ID 820 is a two-bit field that indicates an uplink BWP as the codepoint of the of the downlink control information (DCI) element bandwidth part indicator field as specified in reference [6] below. This field 820 includes the activated/deactivated SP SRS Resource Set. The C field 811 indicates whether the octets including Resource Serving Cell ID field(s) and Resource BWP ID field(s) are present. If field 811 is set to 1, the octets containing Resource Serving Cell ID field(s) and Resource BWP ID field(s) are present; otherwise, they are not present. If the C field is set to 0, this field also indicates the identity of the BWP that includes all resources indicated by the Resource ID fields 830i.

Referring still to FIG. 8, the SUL field 812 indicates whether the MAC CE applies to the NUL carrier or SUL carrier configuration. This field is set to 1 to indicate that it applies to the SUL carrier configuration, and it is set to 0 to indicate that it applies to the NUL carrier configuration. The SRS-ResourceSet ID field 813 is a four-bit field that indicates the SRS Resource Set ID identified by SRS-ResourceSetId as specified in reference [4] cited below, which is to be activated or deactivated. The R fields 804 are reserved bits set to zero. The F₀-F_{M-1} field 837 is a one-bit field that indicates the type of a resource used as a spatial relationship for SRS resource within SRS Resource Set indicated with SRS Resource Set ID field. F0 refers to the first SRS resource within the resource set, F1 to the second one and so on. The field is set to 1 to indicate that an NZP CSI-RS resource index is used, and it is set to 0 to indicate that either a Synchronization Signal Block (SSB) index or an SRS resource index is used. The Resource ID fields 830i are a set of seven-bit fields each including an identifier of the resource used for spatial relationship derivation for SRS resource i (between 0 and M−1). Resource ID0 refers to the first SRS resource within the resource set, Resource IDI to the second one, and so on. If Fi is set to 0, and the first bit of field 830i is set to 1, the remainder of this field includes an SSB-Index as specified in TS 38.331, cited with greater specificity below. If Fi is set to 0, and the first bit of this field 830i is set to 0, the remainder of this field contains SRS-ResourceId as specified in TS 38.331. This field is only present if MAC CE is used for activation when the A/D field 810 is set to one (1).

Unequal UE TX Power. Problems arise when following the channel reconstruction procedure that led to equation (2), above. The reconstructed channel \tilde{h}ₖ may virtually perfectly match the true hₖ when the network is in a noiseless environment and when the BS combines the measurements from N_{A} orthogonal beams. This matching channel reconstruction, however, is only true if the UE uses the same TX power across all the different beams transmitted by the UE in that environment. If the UE does not use the same TX power, additional loss occurs, and the true channel cannot be recovered even in the hypothetical noiseless environment enumerated herein. With reference to the corresponding embodiment of the hybrid ZF precoding procedure employing the normalization step, above, the BS requires identification of the UE TX power for each corresponding BS RX beam to perform the normalization. Further, the UE TX power depends on factors like the RX beam gain at the BS. In short, if the BS has no information about the UE TX power per BS RX beam, then the normalization step is omitted, which may result in a significant performance loss. A loss of greater than 5 decibels (dB) downlink (DL) signal-to-Interference-plus-Noise ratio (SINR) may be anticipated if the normalization step is omitted.

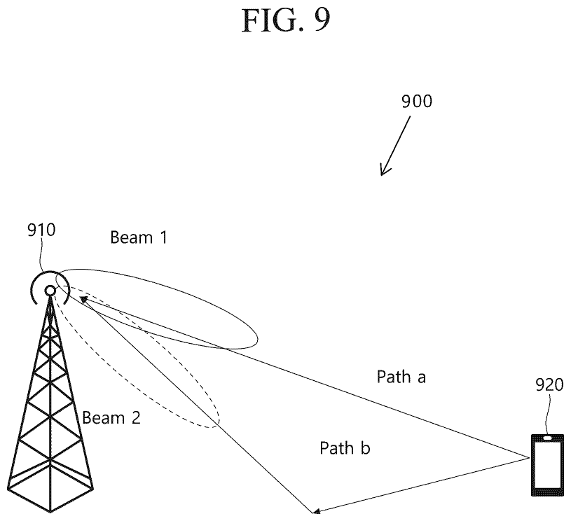

FIG. 9 shows an example conceptual diagram explaining the effect of unequal UE transmit (“TX”) power in a beamforming scenario 900 in accordance with an embodiment. A simple environment 900 is shown in FIG. 9 in which there are two paths from the UE 920 to the BS 910. In this example, path b attenuates the signal by 3 dB compared to path a. It is assumed that the BS has two analog beams, one pointed towards path a, and the other towards path b. During the first SRS transmission, the BS 910 uses beam 1. During the second SRS transmission, the BS uses beam 2. If during the second SRS transmission the UE 920 uses a TX power 6 dB higher than first, then based on the measurements at the BS side, path b has 3 dB gain over path a. Hence, the BS analog precoder will be biased towards focusing the energy on path b, while it should focus the energy on path a. For this reason, the DL performance could be highly degraded if unequal TX powers are used for different SRS transmissions and BS does not know the UE TX powers. The problem is further exacerbated in a more typical noisy multipath environment with many more beams, in addition to the presence of other UEs in the vicinity.

Looking back at SRS transmission in 5G NR, the UE TX power is configured per SRS-ResourceSet separately based on the fields pathlossReferenceRS, p0, and alpha. These parameters determine the UE TX power, assuming the i^{th} RX beam, as follows:

$${P}_{t}^{( i )} = min \{ \begin{matrix}{P}_{max} \\ {P}_{0} + 10 {log}_{10} {2}^{μ} M + α {PL}_{i}\end{matrix} . \qquad ( 3 )$$

where P₀ is the target received power per 180 kHz, M is the number of RBs per SRS transmission, α is the fractional power control parameter (set to one (1) by default), and PLᵢ is the estimated pathloss using the pathlossReferenceRS. The PL is measured through CSI-RS or SSB, and hence, it considers the beam gain of the associated beam with the reference signal, i.e., depending on the BS RX beam, the PL measurement is different yielding to a different UE TX power.

With reference to the initial channel reconstruction approach discussed above in which the BS uses a single SRS resource set with N_{A} resources based on data obtained from the radio resource control (RRC) layer, all the SRS transmissions for the purpose of channel reconstruction are defined within a single SRS-ResourceSet. Consequentially, the UE uses the same TX power for all the resources within this set, which correspond to different BS RX beams. The problems of having unequal/unknown UE TX powers per beam are obviated, subject to the constraint of having at maximum N_{A} RX beams.

With reference to the second channel reconstruction approach discussed above in which the BS may configure N_{A} SRS resource sets (SRS-ResourceSet)-one SRS resource set per beam, it is noteworthy that the unequal UE TX power is not known to the BS unless a constant UE TX power is maintained for all SRS transmissions across the different SRS resource sets. Hence, even if p₀ and a are fixed for all N_{A} resource sets used for channel reconstruction, the UE TX power is different across these sets due to the different path loss associated with using a different BS beam per SRS-ResourceSet.

Wasted power. This disclosure has so far focused on the case where the BS combines the SRS measurements from all its RX beams. However, some beams can be very noisy, such that overall improvement from their measurements is marginal at best. In this example, the BS can employ an energy detection method to only use measurements from beams that have a strong beam gain for a specific user. It can also rely on Reference Signal Received Power (RSRP) reports from the UE to determine the strongest beams. If the set of beams with high beam gain for the specific user is denoted by C, then equation (3) in this case the spatial matrix becomes:

$${\tilde{h}}_{k} = {\sum }_{i ∈ C} ( I ⊗ {p}_{i}^{A} ) {y}_{k , i} . \qquad ( 4 )$$

This solution applies to both approaches discussed above. However, if the measurements from a specific beam will not be used by the BS during channel reconstruction, the UE should not transmit on these beams to save power. It should also be noted that the same problems of unequal UE TX power and wasted power are present when the BS is configured to rely on SRS transmissions to determine the strongest beam out of a set of beams.

With respect to the stated problem of unequal power across different RX beams, a methods and apparatuses are proposed for the BS to send information to UE regarding a group of SRS-ResourceSets that the UE needs to maintain a constant TX power for SRS transmissions across them, with additional configuration for the UE to determine the constant TX power. With respect to the problem of excessive UE power wastage, methods and apparatus are proposed for the BS to send information to a UE with an objective to facilitate the UE to determine a set of active (activated) SRS-ResourceSets (or SRS-Resources), only on which the UE transmits SRSs.

SRS Resource Set Groups with Auto On/Off. Accordingly, in one aspect of the disclosure, channel reconstruction procedures are configured to solve the unequal UE TX power problem observed with respect to the second approach. The first solution for the unequal UE TX power problem is to force the UE to use a constant TX power across all the SRS-ResourceSets used for the purpose of channel reconstruction. This problem is only observed in the second approach where multiple SRS-ResourceSets are used. Notably, there is no direct way to achieve this objective in current standards. To this end, the SRS resource sets used for channel reconstruction are grouped into a new structure denoted by SRS-ResourceSetGroup. This structure, which is a super set, includes the corresponding resource set IDs used for channel reconstruction, and in addition, specifies a rule of power control that will be followed by the UE for all the indicated resource sets. The rule ensures that the UE TX power is constant across all the included resource sets, overriding the power control per resource set. For example, the TX power could be configured to be P_{MAX}, which is the maximum UE TX power, where the UE uses this power across all the resource sets in the group.

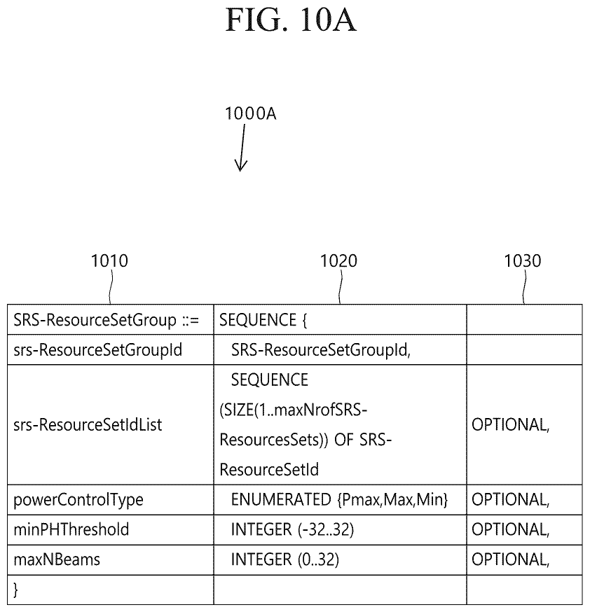

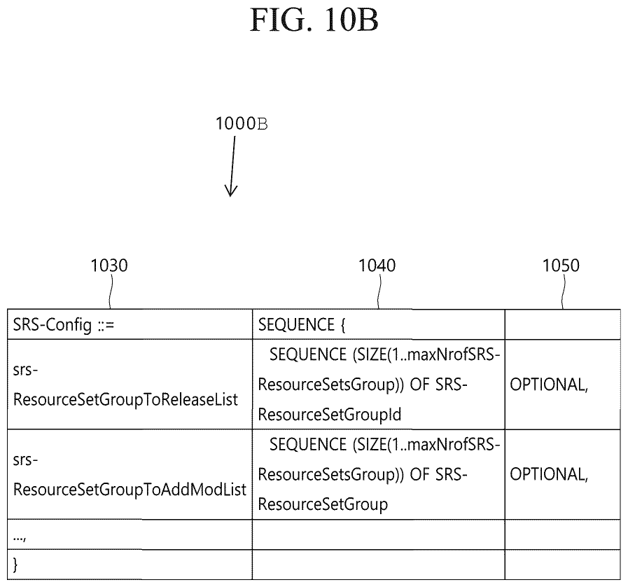

FIG. 10A shows an example signaling field for grouping SRS resource sets 1000A used for SRS channel reconstruction in accordance with an embodiment. Column 1010 includes a first field that defines a new IE styled SRS-ResourceSetGroup. Column 1010 includes a second field that provides an identifier labeled srs-ResourceSetGroupId for the new IE. In addition, column 1010 further includes srs-ResourceSetIdList, which includes the unique IDs for the SRS resource sets associated with this group and that will be known to the UE from which the SRS resource sets were received.

The fourth row of column 1010 is named powerControlType, which indicates a power control rule applied to all resource sets in this group. Referring next to column 1020 in the field corresponding to powerControlType, P_{MAX} indicates to the UE to use its maximum TX power (e.g., Pcmax) for every SRS transmission associated with the resource sets in this group, overriding the SRS power control per SRS resource set. The corresponding parameter Max is pertinent as follows. The UE may find the TX power for all the resource sets in this group using a power control formula similar to equation (3), above. The UE then finds the maximum power across all the resource sets. The UE uses this TX power for every SRS transmission associated with the resource sets in this group, overriding the SRS power control per SRS resource set. The parameter Min is pertinent as follows. The UE finds the TX power for all the resource sets in this group using a power control formula similar to equation (3). The UE then finds the minimum power across all the resource sets. The UE uses this minimum power for every SRS transmission associated with the resource sets in this group, overriding the SRS power control per SRS resource set.

Referring next to the field in column 1010 labeled minPHThreshold, this is an optional parameter that indicates the minimum power headroom (PH) for each SRS resource set to be activated. For example, if the required PH for any SRS resource set is lower than this threshold, then the UE will skip SRS transmission on this resource set (i.e., the SRS resource set is deactivated). The field maxNBeams is relevant to the maximum number of active SRS-ResourceSets. The UE selects the SRS-ResourceSets corresponding to the best maxNBeams RX beams at maximum and skips transmission on the rest of the SRS-ResourceSets within this group of resource sets. The PH or TX power per resource set may be used to perform this procedure. To that end, the resource set corresponding to the best RX beam has the lowest UE TX power and highest PH.

In addition, it is noteworthy that the BS grouping all the SRS resource sets used for channel reconstruction into a single group with any of the powerControlTypes, the UE TX power is ensured to be constant across all the SRS transmission for this group. Thus, for example, the BS can combine the measurements from these SRS transmissions as described by equation (1) and (2), above, without any modification.

Referring to the field powerControlTypes under columns 1010 and 1020 in FIG. 10A, a tradeoff exists between the UE TX power and the channel quality of the reconstructed channel. For example, in terms of channel quality, P_{MAX}>Max>Min, but also in terms of the UE TX power. This relationship intimates that the UE needs to use more power, thereby depleting energy resources more quickly. Accordingly, in another aspect of the disclosure, additional IEs are configured that specify an automatic SRS resource (set) on/off procedure to be used by the UE. Referring again to FIG. 10a and the fifth row of columns 1010 and 1020, a field labeled minPHThreshold is introduced. If this field is provided by the BS to the UE, then the UE decides which resource sets will be active. As noted above, the PH for the i^{th} resource set is defined as follows.

$${PH}_{i} = {P}_{max} - ( {P}_{0} + 10 {log}_{10} ( {2}^{μ} M ) + α {PL}_{i} ) , \qquad ( 5 )$$

where Pₘₐₓ is the max UE TX power as explained above in equation (3). Hence, a negative value of PH means that the power needed for UE MIMO transmissions is higher than the UE max power; that is to say, the UE is power-limited. A positive value, by contrast, means that the UE still has room to increase its TX power. The UE may use minPHThreshold to determine which SRS-ResourceSets to activate, which in turns saves the UE from transmitting power on weak beams. In one embodiment, the UE activates only those SRS resource sets whose PH is greater than minPHThreshold.

With continued reference to FIG. 10A, a field labeled maxNBeams is introduced. If this parameter is configured, then the UE activates up to maxNBeams resource sets in this group, which may correspond to the best maxNBeams BS RX beams. The UE uses the TX power or PH to rank the resource sets and activates those SRS resource sets that correspond to the maxNBeams highest PH values (or the maxNBeams lowest TX power values). As an example, the BS may configure maxNBeams only, minPHThreshold only, both maxNBeams and minPHThreshold, or none of these parameters. If none of these parameters are configured, then the UE transmits SRSs on every SRS resource set in the group. If both parameters are configured, then the UE finds the SRS resource sets whose PH is greater than minPHThreshold. Then the UE activates up to maxNBeams resource sets out of them. If the resource sets that satisfy the minPHThreshold are greater than maxNBeams, then the maxNBeams parameter limits the number of SRS resource sets that can be activated by the UE.

FIG. 10B shows an example signaling field 1000B for enabling a BS to add resource set groups in accordance with an embodiment. Referring initially to column 1030, the IE SRS-Conf includes fields srs-ResourceSetGroupToReleaseList, which allows the BS to remove a prescribed number of SRS-ResourceSetsGroup and thereby eliminates selected channels from 1 to maxNrofSRS-ResourceSetsGroup, or a maximum number of the groups (column 1040). In some embodiments, the groups to be removed are specified by an identifier such as SRS-ResourceSetGroupId, which is a numerical designation of the selected SRS-ResourceSetsGroup. In addition, the reverse operation can be deployed by the BS using the field srs-ResourceSetGroupToAddModList. The number and identity of groups to be added is specified in the third row of column 1040. Columns 1030 and 1050 of FIGS. 10A and 10B, respectively, indicate that the operations are optional.

In short, grouping all the SRS resource sets used for channel reconstruction into a single group with any of the powerControlTypes, the UE TX power is ensured to be constant across all the SRS transmissions for this group.

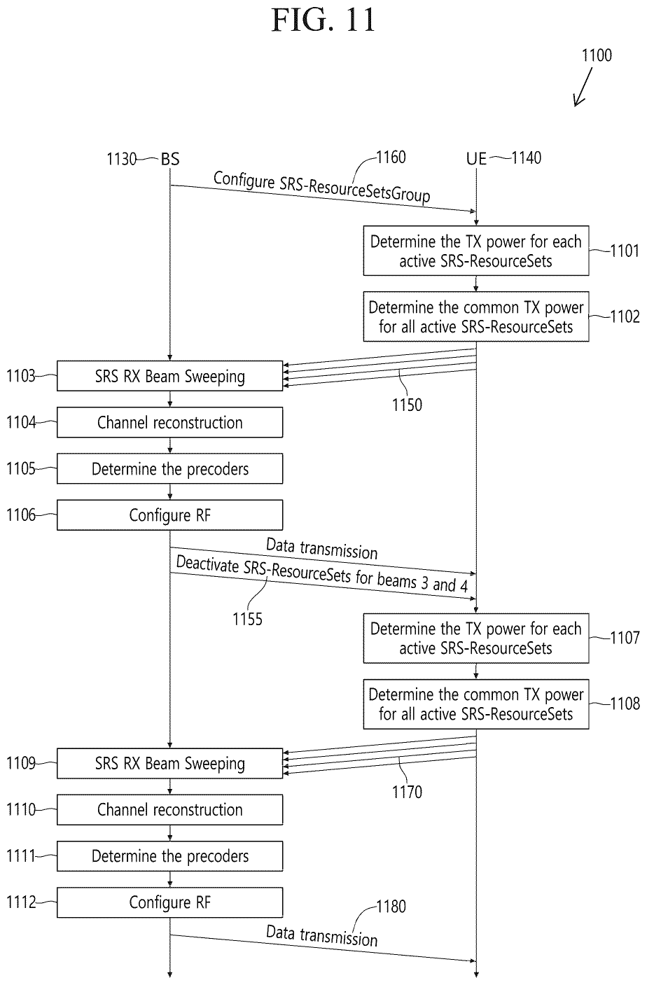

FIG. 11 shows an example signaling diagram 1100 between a UE 1140 and BS 1130 for transmitting data to the UE based on a common TX power for all active SRS resource sets according to an embodiment. In this example, BS 1130 is interacting with UE 1140 using hybrid beamforming. The BS 1130 initiates the exchange by sending a Configure-SRS-ResourceSetsGroup via RRC at 1160. A function of this exemplary IE is to notify the UE to configure and transmit active SRS-ResourceSets to BS 1130. The signaling at 1160 may include transmission, by the BS, of a suitable power control rule for the UE to use that ensures that the UE maintains a constant transmit power across all SRS transmissions specified by the active SRS-ResourceSets in the group. The power control rule may be configured to override conflicting power control rules in the specified SRS resource sets identified in the group. This signaling by the BS of the group information and the power control rule may occur contemporaneously with the SRS-ResourceSets group information in some embodiments. In other embodiments, the BS may signal to the UE the power control rule separately from the SRS resource group information. Thus, the signaling may involve a single BS transmission, or more than one transmission. Thereupon, at logic block 1101, the UE 1140 determines the TX power for each of the active SRS-ResourceSets. Then, at logic block 1102, the UE 1140 determines a common TX power for all active SRS-ResourceSets based on the parameter powerControlType (which in turn is based on the power control rule provided by the BS, above) for the SRS-ResourceSetGroup to conduct SRS transmissions across the corresponding UE beams. It should be noted that if RSRP measurements are available at the BS, the measurements can be used for determining the best beams for each UE. Otherwise, if RSRP measurements are not available, then the BS 1130 needs to activate transmission on all SRS beams every now and then to update the active beams.

As indicated by 1150, the UE, by using the determined common TX power based on the power control rule specified by the BS in 1160, above, transmits SRSs on resources specified in the active SRS-ResourceSets corresponding to all four beams in this example (corresponding with the four arrows). At logic block 1103, the BS 1130 commences SRS RX beam sweeping by adjusting the direction of its RF beam(s) to receive the UE SRS transmissions 1150. At logic block 1104, the BS performs SRS-based channel reconstruction operations as set forth in examples above. At logic block 1105, the BS determines the precoders based on the CSI determined from the channel reconstruction, thereby determining the spatial mapping matrix for use in subsequent data transmission. At logic block 1106, the BS configures the RF for transmitting and receiving data to UE 1140. At 1155, the BS may transmit data to the UE using an optimal RF configuration.

In one embodiment as shown at 1155, the BS may elect, based on the channel conditions or for power savings, capacity, or other criteria, to transmit a signal to the UE deactivate SRS-ResourceSets for specific beams, such as beams 3 and 4. The UE at logic block 1107 may proceed to determine the new common TX power for each currently active SRS-ResourceSets (e.g., without the SRS-ResourceSets corresponding to beams 3 and 4) as in examples described above. In an example, the BS 1130 may use the field srs-ResourceSetGroupToReleaseList to deactivate the two beams. At logic block 1108, the UE determines this common TX power for the active SRS-ResourceSets. Thereupon, at 1170, the UE transmits the new SRS-ResourceSets on beams 1 and 2. Assuming the UE 1140 has four total beams, FIG. 11 shows four total lines: two arrowed lines that constitute the transmission on beams 1 and 2, and two dashed lines to illustrate the absence of any transmission on beams 3 and 4. In like manner at logic block 1109, the BS is using beam sweeping in anticipation of receiving the two transmissions. After receiving the new SRS-based CSI, the BS reperforms channel reconstruction again with the new SRS-ResourceSetGroup at logic block 1110. The new precoders are thereby calculated (logic block 1111) and the RF is configured accordingly (logic block 1112). The BS 1130 may thereupon transmit data at 1180, using one or both available beams.

In still another aspect of the disclosure, the procedures for the SRS-ResourceSetGroup remain in place, together with the parameter powerControlType to maintain a constant UE TX power. However, there is no concept of automatic on/off SRS resource procedures for the UE. As noted, the UE may have to transmit on weak beams, or beams that experience significant SINR. Hence, to solve the UE power wastage problem, semi-persistent SRS-ResourceSets are considered. In this case, all the SRS-ResourceSets are configured as semi-persistent using the resource Type parameter. Semi-persistent SRS-ResourceSets can be activated/deactivated using MAC-CE as illustrated below.

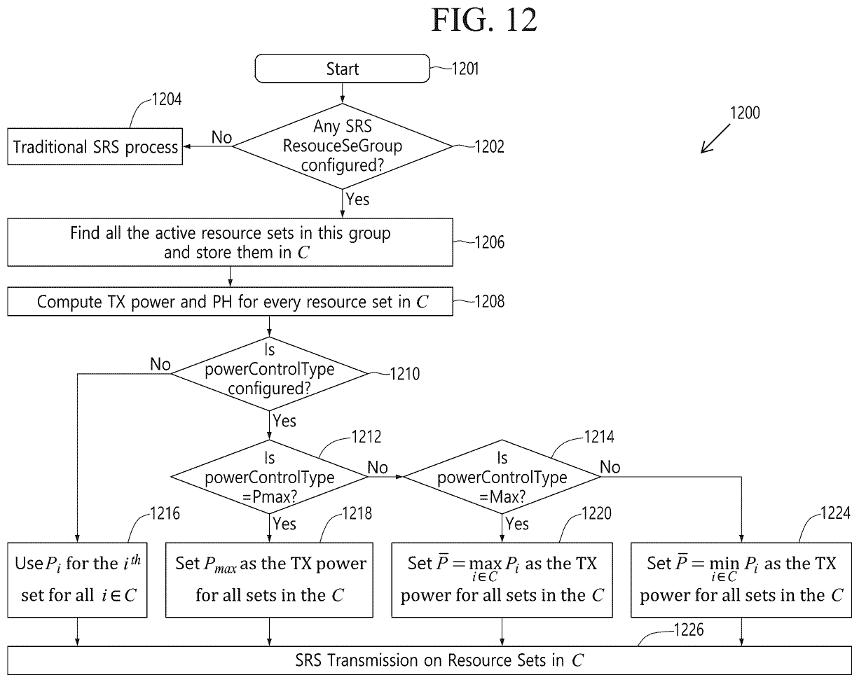

FIG. 12 shows an example flow diagram 1200 of a UE determining a common UE TX power using automatic on/off in accordance with an embodiment. The procedure starts at 1201. At 1202, the UE first checks if there are any SRS-ResourceSetGroup(s) are configured for exchanging data with a BS. If no groups are defined, then at 1204, the UE follows the SRS process as described in embodiments above. Otherwise, at 1206 the UE finds all the active resources in the group and store them in a memory (e.g., a logical memory) C. Those resource sets in the group were activated according to an MAC CE command. At 1208, the UE computes the TX power and PH for every resource set in C. At 1210, the UE determines whether the powerControlType is configured for the group. If the power control type is configured for the group, then at 1212, the UE determines whether powerControlType=P_{MAX}. If so, the UE sets P_{MAX} (at 1218) as the common UE TX power for all resource sets in C. If not, then at 1214 the UE determines whether the powerControlType=Max. If so, then at 1220, the UE uses its

$${max}_{i ∈ C}$$

Pᵢ for all the resource sets in C. If not, then at 1224, the UE determines that powerControlType=Min, and the UE uses its

$${min}_{i ∈ C}$$

Pᵢ for all the resource sets in C. Referring back to 1210, if the UE determines that the powerControlType is not configured, then at 1216, for each resource set in C, the UE uses the corresponding Pᵢ as the TX power for C. Having determined the UE TX power, the UE at 1226 transmits SRSs on resources indicated by the resource sets in C to the subject BS.

It is noteworthy that in FIG. 12, the BS needs to keep track of the best beams for each UE and activate/deactivate the corresponding resource sets accordingly, which may result in a significant amount of MAC-CE messaging, thereby increasing the signaling overhead. Further, the usage parameter for the SRS-ResourceSets is required to set to beamManagement or antennaswitching in this embodiment, or at least in certain implementation of this embodiment. When antennaswitching is set, each SRS-ResourceSet has multiple SRS-Resources corresponding to different UE TX ports.

As noted above, a BS may activate or deactivate individual SRS-ResourceSets using MAC-CE for semi-persistent SRS operations or downlink control channel (DCI) information for aperiodic SRS operations. In an embodiment, a UE may be equipped with an autonomous UE operation for activating or deactivating individual SRS-ResourceSets based on a criterion provided by the BS. For example, a certain threshold of signal-to-noise ratio (SNR), SNIR, PH, or TX power, or another criterion relating to channel conditions, power optimization, transmission quality, etc. The criterion may be a combination of these and need not necessarily be a threshold. The UE uses this received criterion/criteria to determine whether the UE will activate or deactivate certain of these SRS resource sets relating to respective beams. One benefit of this embodiment is a potentially significant reduction in MAC-CE or DCI overhead.

Yet another aspect of the disclosure lacks the use of SRS-ResourceSetsGroup. Following the first approach above, it was evident that unequal TX power did not present a problem when a single SRS-ResourceSet is used for multi-beam sweeping. More precisely, the BS configures a single SRS-ResourceSet for the UE with N_{A} individual resources, where the BS will use each resource to measure the channel using one of its analog beams. Because a single resource set is used, all the UE transmissions across the different resources have the same power based on the configured pathlossReferenceRS. For example, if the BS knows the best analog beam for receiving data from a user, the pathlossReferenceRS may refer to this CSI-RS beam.

This approach can currently be used if N_{A}≤6, since SRSs may in this configuration occupy 6 OFDM symbols at maximum. Furthermore, the BS needs to keep track of RSRP and update pathlossReferenceRS through MAC-CE, to ensure an adequate TX power. Otherwise, the UE TX power may not be enough to have acceptable channel measurements. It is further noted that the usage parameter for the SRS-ResourceSet must be set to beamManagement, to make sure that the UE does not inadvertently switch ports across the different resources within this set. Moreover, the UE may lack individual pathloss measurements corresponding to different analog beams the network may apply, because all the resources in the resource set are associated with a single pathlossReferenceRS.

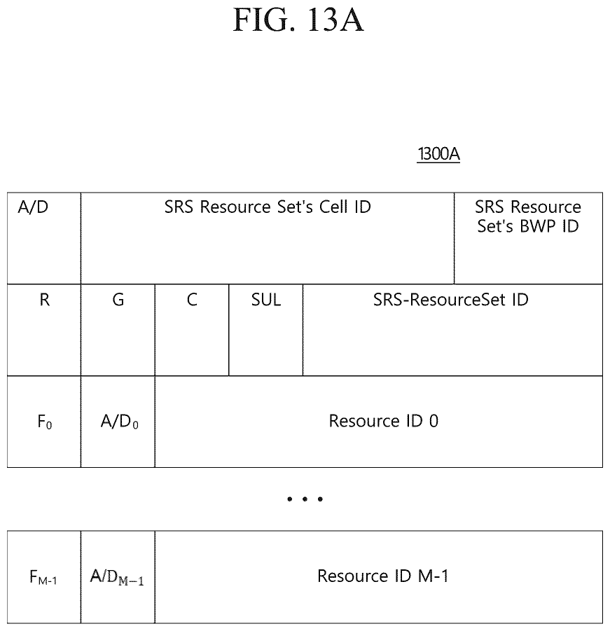

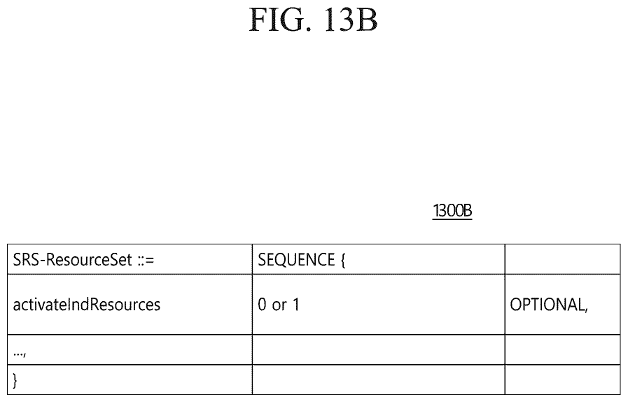

In still another aspect of the disclosure, the BS may activate or deactivate individual resources with a set by using MAC-CE, which is different from present methods. By including an additional parameter to activate individual resources, the BS may activate/deactivate individual SRS resources within the set. FIG. 13A shows an example signaling field 1300A showing a MAC CE for activation or deactivation of individual SRS resources in accordance with an embodiment. The operations differ from those discussed with reference to FIG. 8 in at least the following respects. First, the A/Dᵢ field (with the subscript i appended to identify the SRS resource set to which the operation applies) indicates whether to activate or deactivate indicated SRS resource. The A/Dᵢ field is set to 1 to indicate activation of the SRS resource, otherwise it indicates deactivation. The G field indicates that individual resources will be activated/deactivated in this MAC-CE. In this implementation, the BS should update the set of active resources regularly. It also should be noted that an additional parameter should be present in the SRS-ResourceSet to indicate to the UE that the UE should only transmit SRSs on active SRS-Resources. Thus, in an embodiment, a flag activateIndResources is added to the SRS-ResourceSet. FIG. 13B shows an example signaling field 1300B showing such a flag to indicate to the UE to transmit on active SRS resources in accordance with an embodiment. If activateIndResources is set to one (1), then the UE only transmits SRS on activated SRS-Resource. Otherwise, if activateIndResources is set to zero (0), the UE transmits SRSs on all activateIndResources.

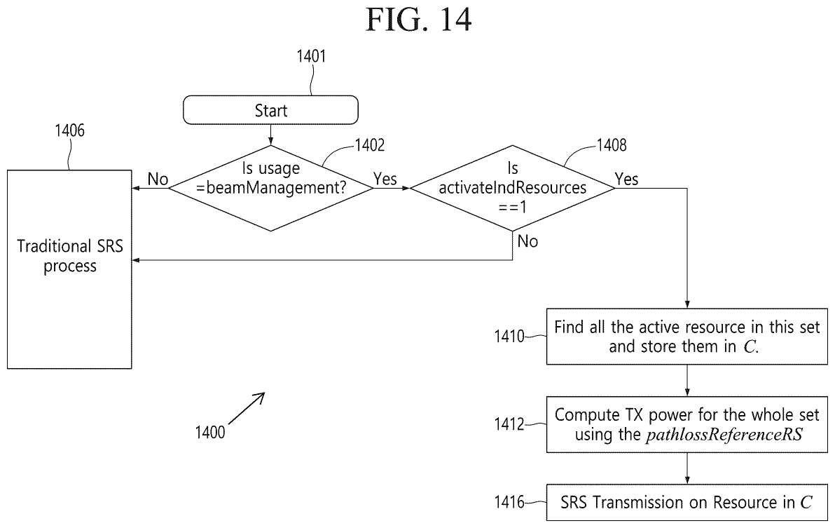

FIG. 14 shows an example flow diagram 1400 illustrating a UE storing and processing data in preparing for SRS-resource set transmissions in accordance with an embodiment. After the routine starts (1401), the UE first checks whether the usage parameter is set to beamManagement for the SRS-ResourceSet. If usage is not set accordingly, then at 1406, the UE may proceed with the SRS resource transmission processes as indicated by a BS in the vicinity. Otherwise, the UE at 1408 determines whether the parameter activateIndResources is defined and set to one (1). If not, then regular SRS processes are followed at 1406. If, however, activateIndResources is defined and set to one (1), the UE finds all the active SRS-Resources-within this set and stores them in C (1410), computes the TX power for the whole set using the parameter pathlossReferenceRS (1412), and then only transmits to a BS the resources defined in C (1416).

In another implementation, the BS may configure parameters like maxNBeams and minPHThreshold proposed in embodiments above for the SRS-ResourceSet. However, the UE currently does not use pathlossReferenceRS to determine the best resources on which to transmit, unlike in the embodiment above where a single pathlossReferenceRS is configured for the whole SRS-ResourceSet. Thus, in another aspect of the disclosure, IE spatialRelationInfo in SRS-Resource (the F₀-F_{M-1} field in FIG. 13A) is used. This parameter is currently used only for the spatial domain transmission filter (beam) used by the UE on which to transmit this SRS-Resource. In this embodiment, however, the UE may be configured to find the measured pathloss using the spatialRelationInfo field configured for each resource and to determine whether to transmit using the subject resource or skip transmission, as in the embodiments above. It should be noted that having different spatialRelationInfo for different SRS resources does not change the UE TX power on this resource, since that latter parameter is determined by pathlossReferenceRS (which is configured for the full set).

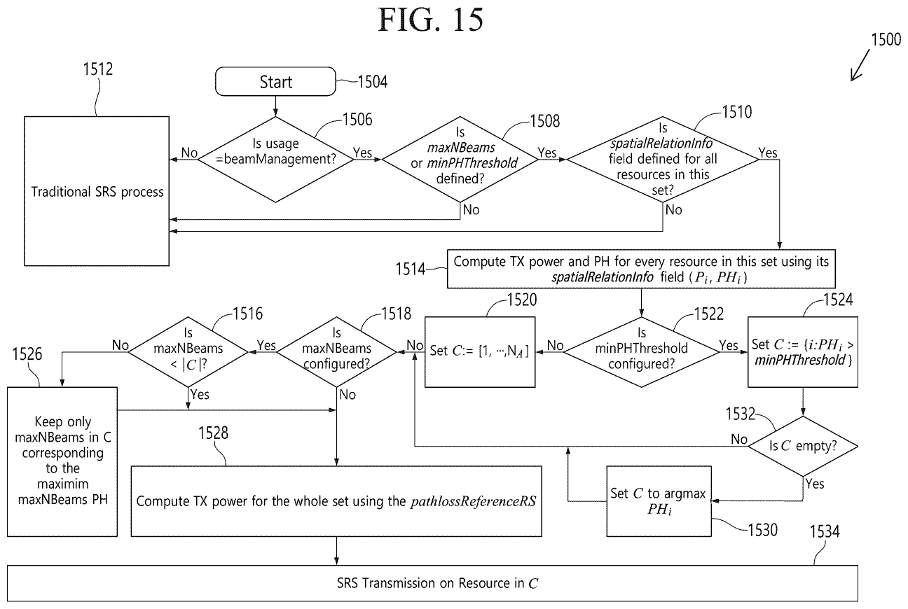

FIG. 15 shows another example flow diagram 1500 illustrating a UE storing and processing data in accordance with an embodiment. It is initially noted that, for the embodiments directed to FIGS. 14 and 15, the usage field value is set to be beam-management, at least in certain implementations. In such a case, spatialRelationInfo should also be present in the SRS-Resource IE. After the algorithm starts (1504), the UE at 1506 first checks if the usage parameter is set to beamManagement for the SRS-ResourceSet. If the usage parameter is not set accordingly, then a conventional SRS process may be followed (1512). Conversely, if the usage parameter is set to beamManagement for the SRS-ResourceSet, the UE checks if any of the parameters maxNBeams or minPHThreshold are defined (1508). If they are not, the conventional SRS process may be used (1512). By contrast, if at least one of the parameters maxNBeams or minPHThreshold are defined, the UE determines whether the spatialRelationInfo is defined for all the SRS-Resources within this SRS-ResourceSet (1510). If not, the conventional SRS process may be followed (1512). If, however, the spatialRelationInfo is defined for all the SRS-Resources within this SRS-ResourceSet, then the UE computes the TX power and the PH for all resources within the set by using the spatialRelationInfo as the pathloss reference signal (1514). Thereafter the UE assesses whether minPHThreshold is configured for the group (1522). If minPHThreshold is configured for the group, then the UE finds all the SRS-Resources that have a PH larger than the minPHThreshold and stores the corresponding IDs of these sets in C (1524). If C is empty after block 1524, the ID of the SRS-Resource with the maximum PH is stored in C (1530). If C is not empty, the UE stores the IDs for all the SRS-Resources within this set in C.

Next, the UE determines whether maxNBeams is configured for this SRS-ResourceSet (1518). If maxNBeams is configured for this SRS-ResourceSet, then the UE determines whether the size of C is greater than maxNBeams (1516). If the size of C is greater than maxNBeams (suggesting a “yes” in decision diamond 1516), the beams corresponding to the maximum maxNBeams within C are preserved within C. Even if the size of C is less than maxNBeams (suggesting a “no” in decision diamond 1516), no further changes are made to C. In either case, the UE next computes the TX power for the whole set using the parameter pathlossReferenceRS (1528). After computing these values, then the UE only transmits using the beam(s) corresponding to the resources defined in C (1534). Thus, in this flow, C corresponds to a list of activated resource sets, and the UE transmit SRS only for the resource sets in C.

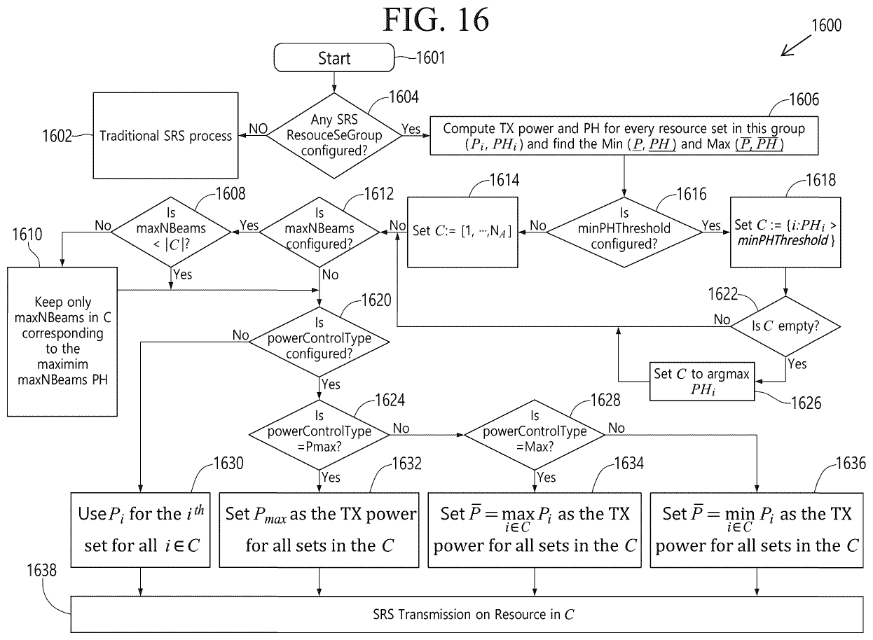

FIG. 16 shows another example flow diagram 1600 for a UE transmitting resource set data with automatic on/off activation capabilities. As in FIG. 15, this method may be performed by a UE upon receiving a signaling request for SRS resources from a base station. After the process begins (1601), the UE first determines whether any SRS-ResourceSetGroup(s) are configured (1604). If no groups are defined, then the conventional SRS process is followed upon receiving signaling from a BS that includes one or more messages requesting the receipt of SRS resources (1602). It should be noted that, in all these UE embodiments expressed in this disclosure, the initial signaling from the BS need not occur in a single message and is not constrained to occur in any given time. That is to say, unless the UE is moving fast relative to the BS and the setup time becomes necessarily shorter, the BS may signal the UE requests for SRS resource sets separately from providing the power rule to be used during the uplink SRS transmission of the UE, or the signaling specifying these criteria may be in a single message, all without departing from the spirit or scope of the present disclosure.

Referring still to FIG. 16, if the UE determines that an SRS-ResourceSetGroup is configured, the UE may compute the TX power and the PH for each SRS-ResourceSet in this group and finds the Min and Max power and PH as defined herein (1606). Thereafter, the UE checks whether minPHThreshold is configured for the group (1616). If minPHThreshold is configured for the group (yes), then the UE finds all the SRS-ResourceSets that have a PH larger than the minPHThreshold and stores the corresponding IDs of these sets in C (1618). Otherwise, if no minPHThreshold is configured for the group, then the UE stores the IDs for all the SRS-ResourceSets in this group in C (1614). After block 1618, the UE determines whether C is empty (1622). For example, minPHThreshold may be configured, but there may not be any PH that exceeds this threshold. If Cis empty (yes), the ID of the SRS-ResourceSet with the maximum PH is stored in C (1626). If C is not empty (no), then regardless of whether minPHThreshold is configured (1616), the UE stores the IDs for all the SRS-ResourceSets in this group in C (1614).

The UE next determines whether the field maxNBeams is configured for the SRS-ResourceSetGroup group (1612). If maxNBeams is configured for the SRS-ResourceSetGroup group (yes), the UE then assesses whether the size of C is greater than maxNBeams (1608). If the UE concludes that the size of C is greater than maxNBeams, the beams corresponding to the maximum maxNBeams within C are maintained in C (1610). That is to say, the UE preserves only the maxNBeams in C that correspond to the maximum maxNBeams (along with the corresponding PH) (1610). If the UE concludes that, conversely, that if the size of C is less than maxNBeams, then the UE performs no other changes to C. Further, if no maxNBeams were found to be configured for the group (1612), the UE makes no further changes to C. The UE instead determines whether the IE powerControlType is configured for the group (1620). If powerControlType is configured for the group (yes), then the power control rule is identified. For example, if powerControlType=P_{MAX} (1624) the UE uses its maximum power (P_{MAX}) for transmitting all the SRS resource sets in C (1632). Otherwise, if powerControlType=Max (1628), then the UE uses its

$${max}_{i ∈ C}$$

Pᵢ for all the resource sets in C (1634). If powerControlType≠Max (1628), then the UE may be configured as powerControlType=Min. If this is the case, the UE uses its

$${min}_{i ∈ C}$$

Pᵢ for all the resource sets in C (1636). Otherwise, if no power control rule for the UE TX power is configured (1620), then for each resource set in C, the UE uses the corresponding Pᵢ as the TX power for the resource sets calculated above (1606). Once the UE TX power is determined, the UE proceeds to transmit across all SRS resource sets in C to the requesting BS.

In the example embodiment of FIG. 16, C corresponds to a list of activated resource sets, and the UE transmit SRS only for the resource sets in C. Further, the usage parameter for the SRS-ResourceSets should in certain implementations be set to beamManagement or antennaswitching. When antennaswitching is set, for example, each SRS-ResourceSet has multiple SRS-Resources corresponding to different UE TX ports.

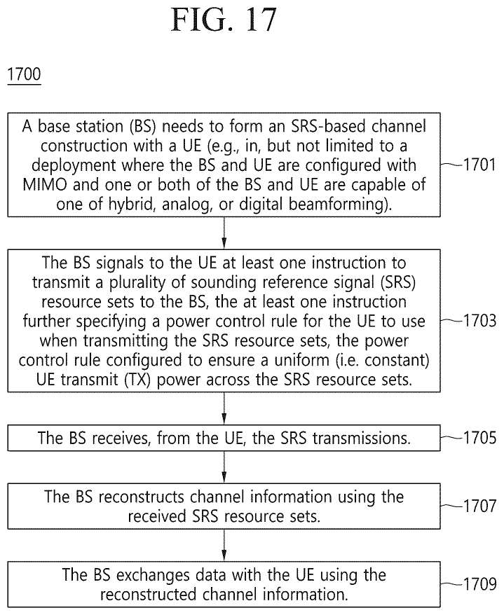

FIG. 17 shows another example flow diagram 1700 for a base station performing an SRS-based channel reconstruction in accordance with an embodiment. While the example in FIG. 17 may extend to any number of physical implementations, one such non-exhaustive limitation is directed to a deployment where the BS and UE are configured with MIMO and one or both of the BS or UE are capable of one of hybrid, analog, or digital beamforming using a group of SRS resource sets for calculation of the spatial matrix information for the precoder, the array of relative weights and phase shifts for the beamformer for use in channel reconstruction. In other embodiments, these concepts may not be necessary.

Referring first to block 1701, a base station (BS) needs to form an SRS-based channel construction with a UE. Accordingly, at block 1703, the BS signals to the UE at least one instruction to transmit a plurality of sounding reference signal (SRS) resource sets to the BS, the at least one instruction further specifying a power control rule for the UE to use when transmitting the SRS resource sets, the power control rule configured to ensure a uniform (i.e. constant) UE transmit (TX) power across the SRS resource sets. Physically this may denote that the UE transmits one SRS resource set per active UE beam. These instructions may be through RRC or another protocol in other embodiments. The plurality of SRS resource sets may form a group. Within the group or merely associated with the group is the power control signal. It is noteworthy that the information may be sent to the UE in a single transmission, or in multiple transmissions over time. Further, the SRS resource set request may be separate from, or together with, the power control information as conveyed to the UE.

Thereafter, at block 1705, the BS receives, from the UE, the SRS resource sets transmitted across the corresponding UE beams at constant UE transmit power using the provided power rule. The BS may use the received SRS transmissions to determine a best beam to be used for data transmissions to the UE. At 1707, the BS reconstructs channel information using the received SRS resource sets. The reconstructed channel information may be used to design the beam. In another embodiment, the BS measures the SNR for each SRS transmissions and selects the beam associated with the SRS transmissions with highest SNR. RSRP or SINR may be used instead of or in addition to SNR. The channel information may correspond to one or more UE beams, up to the number of beams described by the SRS resource set associated with the beam.

Then, at block 1709, the BS exchanges data with the UE using the reconstructed channel information. In the example of a MIMO beamforming system, the BS may transmit to all the UE beams using the channels, or the BS may transmit to a subset of the beams where the BS deactivates one or more of the beams. In the simplest scenario and assuming that the BS is still using spatial multiplexing, the UE is equipped with one antenna and the BS transmits to the UE receive beam corresponding to that antenna.

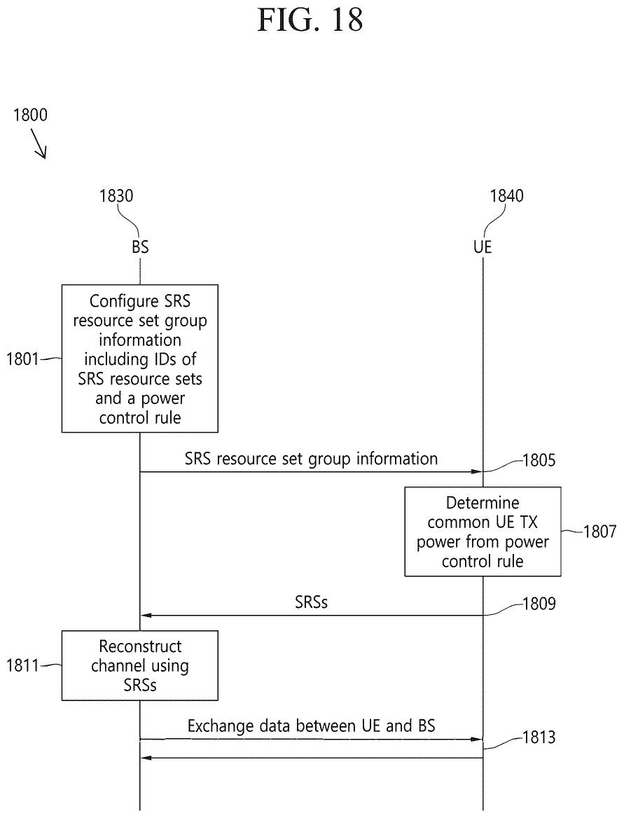

FIG. 18 is an example signaling diagram 1800 for SRS channel reconstruction in accordance with an embodiment. This configuration may be performed by a BS 1830 and UE 1840. At 1801, the BS configures SRS resource set group information. The group includes IDs corresponding to the relevant SRS resource sets in the group. The group includes a power control rule, as above, for the UE to use in determining a common TX power to transmit SRSs across any or all of the SRS resource sets in the group.

At 1805, the BS 1830 then transmits the SRS resource set group information to UE 1840, which specifies the resource sets and the power control rule. In some embodiments, the group information is sent together. In other embodiments, the power control rule is sent separately from the IDs by the BS. In still other embodiments, this information may be sent across several transmissions. Using this information, the UE then defines at 1807 a common UE transmit power based on application of the power control rule, for sending subsequent SRSs to the BS.

Thereafter, at 1809, the UE transmits one or more SRSs to the BS using the determined common UE transmit power across the different resource sets, or all resource sets, the latter category corresponding to a scenario wherein the UE has no discretion to deactivate certain SRS resource sets. Using received SRSs, the BS reconstructs the channel information at 1811. At 1813, the UE and BS proceed to exchange data using the maximized channel and beam conditions.

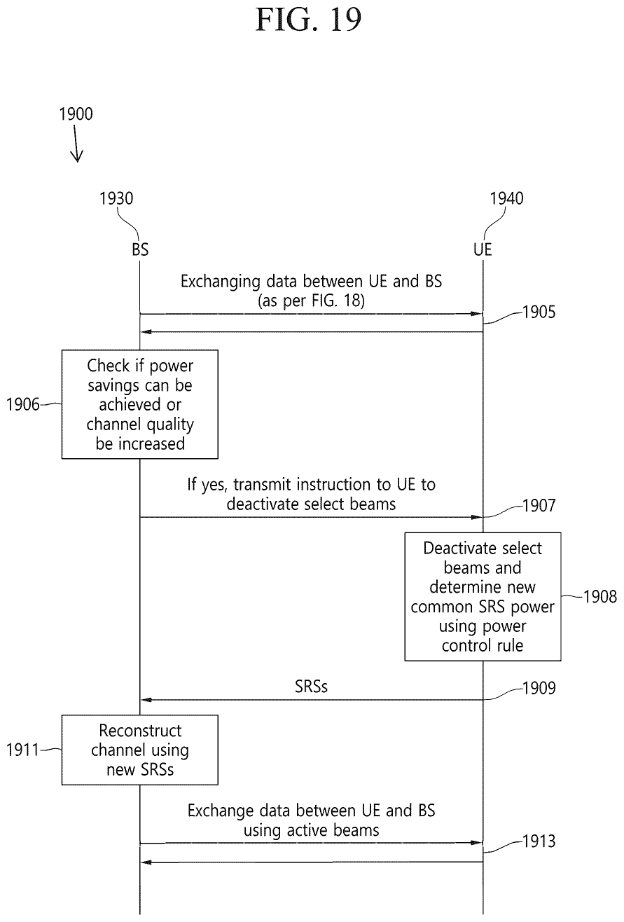

FIG. 19 is another example signaling diagram 1900 for deactivating beams in accordance with an embodiment. Here, B S 1930 and UE 1940 correspond to BS 1830 and UE 1840 from FIG. 18. At 1905, the same channels as established in FIG. 18 are used for the UE and BS to continue to exchange data. At 1906, the BS may, at periodic intervals or at random, may check to determine whether power savings can be achieved or whether the channel quality between the UE and BS can be increased. If the BS determines that one or the other conditions apply, then the BS at 1907 instructs the UE to deactivate select beams to accomplish this purpose. The UE receives the message and at 1908, the UE deactivates the select beams and determines a new common SRS transmit power using the power control rule (or another BS power control rule if one was sent at 1908). It should be noted that in these embodiments, the UE has been given the ability to activate or deactivate beams in accordance with the principles set forth above. Next, at 1909, the UE 1940 transmits SRSs with the determined SRS power to the BS 1930 using the select active SRS resource sets. At 1911, the BS 1930 uses this new CSI to reconstruct the channel with the UE (i.e., based on the newly transmitted SRSs). At 1913, the BS 1930 and UE 1940 use this new channel information to exchange data using the active beams.

Accordingly, with reference to certain of the various aspects and embodiments described herein, in a first embodiment the BS defines a common power control rule across multiple SRS-ResourceSets, each configured with its own power control parameters, to ensure a constant transmit power across the selected SRS-ResourceSets. These embodiments correspond to the second approach, above. The power control rule may be the min, max, mean, median, etc., of the transmit power of each set in the desired SRS-ResourceSets. As noted, a group of SRS-ResourceSets, referred to as SRS-ResourceSetsGroup, may be defined and employed such that the UE is configured to maintain a constant TX power across all SRS resource sets in the group. In an embodiment described above, the group may be formulated with the BS aggregating the IDs of all SRS resource sets to be employed. Another aspect is summarized as follows. A technique was introduced for the BS to send information to the UE to enable the UE to autonomously determine a set of active (activated) SRS-ResourceSets (or individual SRS-Resources. The UE transmits SRS resource information only within these resource sets and may skip transmissions on other SRS-ResourceSets (or SRS-Resources), without requiring additional MAC-CE or DCI messaging.

It was also noted that currently, individual SRS-ResourceSets can be activated/deactivated by the BS using MAC-CE (semi-periodic) or DCI (aperiodic). The techniques enumerated immediately above enable the BS to configure a criterion for the UE to autonomously activate/deactivate the individual SRS-ResourceSets without the need for MAC-CE or DCI messaging. The criterion may be based on the SNR, Tx power, PH, or others. It was further noted that in the current specification, the BS cannot turn on/off individual resources in an SRS-ResourceSet. These techniques accord the BS with the ability to activate/deactivate individual resources in an SRS-ResourceSet through MAC-CE or DCI and/or enabling the BS to configure a criterion (or more than one criterion for the UE to autonomously activate/deactivate the individual SRS-Resources without the need for MAC-CE or DCI messaging.

In addition, it was noted that in an aspect, the BS may define a common power control rule across multiple SRS-ResourceSets, each configured with its own power control parameters, to ensure a constant transmit power across the selected SRS-ResourceSets. As an example, as noted the SRS resource sets used for channel reconstruction into a new structure denoted SRS-ResourceSetsGroup. These embodiments include the corresponding resource set IDs used for channel reconstruction, and in addition, they specify a rule of power control that for the UE to adhere for all the indicated resource sets. The rule ensures that the UE TX power is constant across all the included resource sets, overriding the power control operations or protocols associated with (including within) the SRS per resource sets. For example, the TX power may be configured to be Pₘₐₓ, which is the maximum UE TX power, where the UE uses this power across all the resource sets in the group. Other options for the common power control include a minimum power (min), a maximum power as described above (max), a mean power, a median power, and other options.

In further summary, another aspect was described for enabling autonomous UE operation. It was described that the BS may currently activate/deactivate individual SRS-ResourceSets using MAC-CE for semi-persistent SRS or DCI for aperiodic SRS. These embodiments advantageously enable an autonomous UE operation with auto activation/deactivation of SRS-ResourceSets based on a certain criterion (or criteria) provided by the BS. For example, a certain threshold of SNR, PH, Tx power, or another rule or condition related to power savings, channel optimization, interference minimization, and the like, may be provided by the BS to the UE, which is thereafter utilized by the UE to determine whether the UE elects to activate/deactivate a certain SRS-ResourceSets. Noted advantages of these embodiments include potentially substantial reduction of the MAC-CE or DCI overheads. These embodiments correspond to the second approach, but they can be extended to include further operations.

It was also noted that the above-summarized embodiments may be combined to exploit the new IE SRS-ResourceSetsGroup. Two additional optional parameters can be added to the SRS-ResourceSetsGroup configuration. The first parameter may determine the maximum number of active SRS-ResourceSets, denoted by maxNBeams. If this parameter is configured, then the UE selects the SRS-ResourceSets corresponding to the best maxNBeams RX beams. Weaker or poorer quality beams can consequently be discarded, increasing quality and reliability of transmission by the UE over the beams. The second parameter that was noted is the minimum PH threshold. A lower PH for a UE indicates a weaker RX beam. If the PH for a certain SRS-ResourceSet is lower than this threshold, the UE may skip transmitting on this resource set. These embodiments advantageously may result in at least power savings (conservation of both UE and PS power), increased quality of the spatial channels in use, increased BS capacity for other UEs, and the like.

It was further noted that in other embodiments, the BS may first configure the SRS-ResourceSetGroup along with the common power control rule to be used across them. The BS may also configure the criterion/criteria to be used by the UE to determine the active SRS-ResourceSets. This BS may signal this information to the UE as needed. After receiving the configuration, the UE determines the uniform TX power it will use for all SRS transmission related to the configured SRS-ResourceSetGroup along with the active SRS-ResourceSets. The UE may dynamically change in or near real-time set(s) within the active SRS resource sets. Moreover, the UE can dynamically change in or near real-time the available measurements made by the UE based on the criterion (criteria) defined by the BS. The UE is beneficially accorded substantial latitude in maximizing transmission quality.

In further summary, embodiments were disclosed directed to the first approach, but extendible to other applications, as follows. A single SRS-ResourceSet is used with multiple resources therewithin. Each individual resource may correspond to a BS RX beam. As noted, current standards provide no mechanism for the BS to activate/deactivate individual SRS resources within a set. One embodiment disclosed gives the BS the ability to activate/deactivate individual resources through MAC-CE or DCI. Also, in certain of these embodiments, the autonomous UE procedure may be extended to the first approach. In yet other embodiments, the BS is given the ability to activate/deactivate individual resources using MAC-CE. It was noted that presently, the BS may activate/deactivate the whole resource set, but not individual resources. One embodiment solved this problem by including an additional parameter to activate individual resources, referred to as G. This parameter may be identified in a current unused IE or created as a new field. In a further embodiment described above, the BS may be operable to provide additional configuration(s) to a UE to enable autonomous UE operation. In this case, the UE does not use the IE pathlossReferenceRS to determine the best resources on which to transmit, because a single pathlossReferenceRS is configured for the whole SRS-ResourceSet. Instead, one embodiment uses the IE spatialRelationInfo in the SRS-Resource field. This parameter is currently used only for the spatial domain transmission filter (beam) used by the UE to transmit on the subject SRS-Resource. In these embodiments, the UE is configured to find the measured pathloss using the spatialRelationInfo field configured for each resource and determine whether to transmit on this resource or skip transmission as in the second proposal, above. It was noted that having different spatialRelationInfo for different SRS resources does not change the UE TX power on this resource, since that criterion is determined by pathlossReferenceRS, which is configured for the whole set. In a further embodiment, additional parameters may be included to indicate to the UE whether it can deactivate some SRS-resources.

In sum, enabling adaptive analog beamforming and/or joint analog and digital beamformers currently relies on the knowledge of the full-element channel. The autonomous UE with automatic on/off is especially important for 6G with the current focus on energy efficiency. An autonomous UE also reduces signaling overhead.

While this disclosure focuses predominantly on solutions for hybrid precoding and channel estimation compatible with the 3GPP standard, the solutions may also be implemented in X-MIMO systems, for example. However, any of these technologies disclosed herein may be extended to other applications and need not be limited to 3GPP. Examples include implementing these technologies in products embodying the family of IEEE 802.11 wireless communication protocols, in which MIMO techniques and beamforming may also be employed. Further, as 6G standards continue to evolve, the techniques herein may be optimal to overcome many of the challenges and constraints that are discussed above, including solving new problems as 6G continues its evolution. In addition, the principles of the disclosure may be equally applicable to implementations in LTE (4G), LTE-A, 5G, 5G-A, and other presently unknown further specifications and products embodying those specifications.

The following documents and standards descriptions are hereby incorporated by reference into the present disclosure as if fully set forth herein:
[1] A. Alkhateeb, O. El Ayach, G. Leus and R. W. Heath, “Channel Estimation and Hybrid Precoding for Millimeter Wave Cellular Systems,” in IEEE Journal of Selected Topics in Signal Processing, vol. 8, no. 5, pp. 831-846, October 2014.
[2] A. AlAmmouri, R. Mishra, J. Mo, YH. Nam, “Methods and Apparatus of Channel Estimation, Hybrid-Precoding and Scheduling of Multi-User MIMO,” WD-202304-004-1-US0.
[3] YH. Nam, B. Sadiq, J. Mo, A. AlAmmouri, “Estimating Channel State Information in Advanced MIMO Antenna Systems for Cellular Communications,” WD-202209-017-1-US0.
[4] 3GPP TS 38.331 Release 17, Radio Resource Control (RRC) and Protocol specification, May 2022.
[5] 3GPP TS 38.321 Release 17, Medium Access Control (MAC) protocol specification, April 2023.
[6] 3GPP TS 38.212 Release 17, Multiplexing and channel coding, April 2023.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A base station (BS), comprising:
a transceiver configured to:
transmit, to a user equipment (UE), (i) resource set group information including identifiers (IDs) of a plurality of sounding reference signal (SRS) resource sets, wherein each of the plurality of SRS resource sets corresponds to a different receive beam, and (ii) a power control rule to ensure a constant transmit power across the plurality of SRS resource sets; and
receive SRSs on at least one SRS resource set of the plurality of SRS resource sets; and
a processor operably coupled to the transceiver, the processor configured to, based on the received SRSs, identify a beam.

2. The BS of claim 1, wherein the beam is identified based on reconstructed channel information.

3. The BS of claim 1, wherein:
the processor is further configured to measure a metric for each of the received SRSs, and the beam corresponds to a beam with a highest metric.

4. The BS of claim 3, wherein the metric is one of signal-to-noise ratio (SNR), signal-to-interference-plus-noise ratio (SINR), or reference signal received power (RSRP).

5. The BS of claim 1, wherein the power control rule is configured to ensure precedence over other transmit power rules in the plurality of SRS resource sets.

6. The BS of claim 1, wherein:
the power control rule relates to use of a maximum power, a minimum power, a mean power, a median power, or a weighted sum of a plurality of transmit powers, as a transmit power for the SRSs, and
the plurality of transmit powers correspond to the plurality of SRS resource sets.

7. The BS of claim 1, wherein the resource set group information includes a parameter to allow selective transmission of SRSs on at least one active SRS resource set.

8. A user equipment (UE), comprising:
a transceiver configured to:
receive, from a base station (BS), (i) resource set group information including identifiers (IDs) of a plurality of sounding reference signal (SRS) resource sets, wherein each of the plurality of SRS resource sets corresponds to a different receive beam, and (ii) a power control rule to ensure a constant transmit power across the plurality of SRS resource sets; and
a processor operably coupled to the transceiver, the processor configured to:
identify at least one active SRS resource set of the plurality of SRS resource sets; and
determine the constant transmit power for the at least one active SRS resource set using the power control rule;
wherein the transceiver is further configured to transmit SRSs on the at least one active SRS resource set.

9. The UE of claim 8, wherein the transceiver is further configured to:
receive, from the BS after transmitting the SRSs on the at least one active SRS resource set of the plurality of SRS resource sets, an identity of a beam.

10. The UE of claim 8, wherein the resource set group information includes a parameter to instruct the UE to selectively transmit the SRSs on the at least one active SRS resource set of the plurality of SRS resource sets.

11. The UE of claim 10, wherein the parameter includes a power threshold or a power headroom threshold for enabling the processor to identify the at least one active SRS resource set of the plurality of SRS resource sets.

12. The UE of claim 8, wherein the transceiver is further configured to:
receive, from the BS, medium access control (MAC) control elements (CEs) for the UE to determine at least one active SRS resource set used for the UE to transmit SRSs,
each of the MAC CEs including an identifier of an SRS resource set and a field indicating whether the identified SRS resource set is activated or deactivated.

13. The UE of claim 8, wherein:
the power control rule relates to use of a maximum power, a minimum power, a mean power, a median power, or a weighted sum of a plurality of transmit powers, as a transmit power for the SRSs, and
the plurality of transmit powers correspond to the plurality of SRS resource sets.

14. The UE of claim 8, wherein the power control rule is configured to ensure precedence over other transmit power rules in the plurality of SRS resource sets.

15. A method performed by a base station (BS), the method comprising:
transmitting, to a user equipment (UE), (i) resource set group information including identifiers (IDs) of a plurality of sounding reference signal (SRS) resource sets, wherein each of the plurality of SRS resource sets corresponds to a different receive beam, and (ii) a power control rule to ensure a constant transmit power across the plurality of SRS resource sets;
receiving SRSs on at least one SRS resource set of the plurality of SRS resource sets; and
identifying, based on the received SRSs, a beam.

16. The method of claim 15, wherein the beam is identified based on reconstructed channel information.

17. The method of claim 15, further comprising measuring a metric for each of the received SRSs, wherein the beam corresponds to a beam with a highest metric.

18. The method of claim 17, wherein the metric is one of signal-to-noise ratio (SNR), signal-to-interference-plus-noise ratio (SINR), or reference signal received power (RSRP).

19. The method of claim 15, wherein the power control rule is configured to ensure precedence over other transmit power rules in the plurality of SRS resource sets.

20. The method of claim 15, wherein:
the power control rule relates to use of a maximum power, a minimum power, a mean power, a median power, or a weighted sum of a plurality of transmit powers, as a transmit power for the SRSs, and
the plurality of transmit powers correspond to the plurality of SRS resource sets.
